(19) United States
(12) Patent Application Publication
(10) Pub. No.: US 2026/0161690 A1
(43) Pub. Date: Jun. 11, 2026

(54) INFORMATION PROCESSING SYSTEM AND INFORMATION PROCESSING METHOD

(71) Applicant: SEMICONDUCTOR ENERGY LABORATORY CO., LTD., Atsugi-shi (JP)

(72) Inventors: Junpei MOMO, Sagamihara (JP); Hiroki HOSOSHIMA, Atsugi (JP); Aoi NAKAMURA, Atsugi (JP)

(21) Appl. No.: 19/395,684

(22) Filed: Nov. 20, 2025

(30) Foreign Application Priority Data
Dec. 6, 2024 (JP) 2024-213175

(51) Int. Cl. G06F 16/334; G06F 16/3332

(52) U.S. Cl. CPC G06F 16/3344; G06F 16/3334; G06F 16/3338

(57) ABSTRACT

Provided is a novel information processing system that is highly convenient, useful, or reliable. The information processing system includes three components. A first component has a function of receiving and transmitting a knowledge graph and a function of receiving and providing a document. A second component has a function of performing processing with a large language model, and transmitting a document in response to a prompt chain. A third component has a function of receiving and sharing a knowledge graph, a function of executing a prompt chain, and a function of receiving and transmitting a document. In the information processing system, a subcomponent searches for a path between nodes and another subcomponent creates a prompt. The large language model generates a document in response to the prompt. As a result, a document in which the relation between components in a scope of claims or elements is described can be generated.

### BACKGROUND OF THE INVENTION

### 1. Field of the Invention

One embodiment of the present invention relates to an information processing system, an information processing method, or a semiconductor device.

One embodiment of the present invention is not limited to the above technical field. The technical field of one embodiment of the present invention disclosed in this specification and the like relates to an object, a method, or a manufacturing method. One embodiment of the present invention relates to a process, a machine, manufacture, or a composition of matter. Thus, more specifically, examples of the technical field of one embodiment of the present invention disclosed in this specification and the like include an information processing device, a semiconductor device, a memory device, a method for driving any of these devices, and a method for manufacturing any of these devices.

### 2. Description of the Related Art

In recent years, language models using neural networks have been actively developed, and large language models (LLM) have particularly attracted attention. A large language model is a natural language processing model trained using a large amount of data. With a large language model, for example, an interactive model that provides an answer to a user's instruction can be achieved. In Non-Patent Document 1, Generative Pre-trained Transformer 4 (GPT-4, registered trademark) is disclosed as a large language model, and ChatGPT is disclosed as an interactive model.

By utilizing a large language model, the capability of a natural language processing model has been significantly increased. On the other hand, owing to the expansion of the language model, it is difficult to incorporate and operate a language model on one's own from the aspect of facilities and costs. Accordingly, a language model provided by an external service is generally used.

A document search system that searches for a document with the concept of the document taken into account has been proposed (Patent Document 1). The document search system includes a processing portion. A search graph is created in the processing portion from search text. The search graph includes first to m-th (m is an integer greater than or equal to one) search local graphs, and each of the search local graphs includes two nodes and one edge. The processing portion searches a reference document for first to m-th sentences. The i-th (i is an integer greater than or equal to one and less than or equal to m) sentence includes one of two nodes in the i-th search local graph or a related term or a hyponym of the one of the two nodes; the other or the two nodes in the i-th search local graph or a related term or a hyponym of the other or the two nodes; and an edge in the i-th search local graph or a related term or a hyponym of the edge. The reference document is scored in accordance with the number of sentences included in the reference document among the first to m-th sentences.

### References

[Patent Document 1] PCT International Publication No. WO2021/140406 pamphlet
[Non-Patent Document 1] Summary of ChatGPT/GPT-4 Research and Perspective Towards the Future of Large Language Models, Yiheng Liu et al., (submitted on 4 Apr. 2023) [online], Internet URL: https://arxiv.org/abs/2304.01852

### SUMMARY OF THE INVENTION

One object of one embodiment of the present invention is to provide a novel information processing system that is highly convenient, useful, or reliable. Another object of one embodiment of the present invention is to provide a novel information processing method that is highly convenient, useful, or reliable. Another object of one embodiment of the present invention is to provide a novel information processing system, a novel information processing method, or a novel semiconductor device.

The description of these objects does not preclude the existence of other objects. One embodiment of the present invention does not need to achieve all these objects. Other objects will be apparent from and can be derived from the description of the specification, the drawings, the claims, and the like.

(1) One embodiment of the present invention is an information processing system including a first component, a second component, and a third component.

The first component is configured to receive a first knowledge graph and transmit the first knowledge graph to the third component and is configured to receive and provide a first document. The first knowledge graph includes a first group of nodes. Each of the first group of nodes includes a first field and a second field. The first field stores an attribute showing a scope of claims. The second field stores one of first words or phrases recognized as an element in the scope of claims. The first document describes a relation between a first element and a second element. Each of the first element and the second element is included in the first words or phrases.

The second component is configured to transmit the first document to the third component in response to a prompt chain and is configured to perform processing with a large language model. The large language model is configured to generate the first document in response to a first prompt.

The third component is configured to receive the first knowledge graph and share the first knowledge graph within the third component, is configured to execute the prompt chain, and is configured to receive the first document and transmit the first document to the first component. The prompt chain includes the first prompt. The third component includes a first subcomponent and a second subcomponent.

The first subcomponent is configured to acquire a first node and a second node from the first group of nodes. The first node stores the first element in the second field, and the second node stores the second element in the second field. The first subcomponent is configured to search for a first path between the first node and the second node and is configured to share the first path within the third component.

The second subcomponent is configured to create the first prompt. The first prompt includes a first instruction and the first path. The first instruction includes a procedure for generating the first document describing the relation between the first element and the second element using the first path.

In this manner, a pair of nodes including the first node that stores the first element in the second field and the second node that stores the second element in the second field can be found from the first knowledge graph, for example. Furthermore, a path connecting the first node and the second node can be found, for example. Moreover, the first document that describes the relation between elements of an invention in the scope of claims can be generated. The first document can be generated via graph data extracted from the first knowledge graph, in which case the relation between the elements can be described more accurately. In addition, the basis for the first document can be provided using the first knowledge graph. As a result, a novel information processing system that is highly convenient, useful, or reliable can be provided.

(2) Another embodiment of the present invention is the above information processing system in which the first component is configured to receive a second knowledge graph and transmit the second knowledge graph to the third component and is configured to receive and provide a second document.

The second knowledge graph includes a second group of nodes. Each of the second group of nodes includes a third field, a fourth field, and a fifth field. The third field stores an attribute showing a prior art document. The fourth field stores one of second words or phrases recognized as an element. The fifth field stores the one of the first words or phrases or a false value. The one of the first words or phrases is determined to have a correspondence with the one of the second words or phrases. The second document describes a relation between a third element and a fourth element. Each of the third element and the fourth element is included in the second words or phrases.

The second component is configured to transmit the second document to the third component in response to the prompt chain. The large language model is configured to generate the second document in response to a second prompt.

The third component is configured to receive the second knowledge graph and share the second knowledge graph within the third component and is configured to receive the second document and transmit the second document to the first component. The prompt chain includes the second prompt.

The first subcomponent is configured to acquire a third node and a fourth node from the second group of nodes. The third node stores the third element in the fourth field and stores the first element in the fifth field. The fourth node stores the fourth element in the fourth field and stores the second element in the fifth field. The first subcomponent is configured to search for a second path between the third node and the fourth node and is configured to share the second path within the third component.

The second subcomponent is configured to create the second prompt. The second prompt includes a second instruction and the second path. The second instruction includes a procedure for generating the second document describing the relation between the third element and the fourth element using the second path.

In this manner, a pair of nodes including the third node that stores the first element in the fifth field and the fourth node that stores the second element in the fifth field can be found from the second knowledge graph, for example. Furthermore, a path connecting the third node and the fourth node can be found, for example. Moreover, the second document that describes the relation between elements described in the prior art document can be generated. The second document can be generated via graph data extracted from the second knowledge graph, in which case the relation between the elements can be described more accurately. In addition, the basis for the second document can be provided using the second knowledge graph. As a result, a novel information processing system that is highly convenient, useful, or reliable can be provided.

(3) Another embodiment of the present invention is the above information processing system in which the first component is configured to receive and provide a comparison document. The comparison document describes a difference between the relation between the first element and the second element and the relation between the third element and the fourth element.

The second component is configured to transmit the comparison document to the third component in response to the prompt chain. The large language model is configured to generate the comparison document in response to a third prompt.

The third component is configured to receive the comparison document and transmit the comparison document to the first component. The prompt chain includes the third prompt.

The second subcomponent is configured to create the third prompt. The third prompt includes a third instruction, the first document, and the second document. The third instruction includes a procedure for comparing the first document and the second document to generate the comparison document describing the difference between the relation between the first element and the second element and the relation between the third element and the fourth element.

In this manner, a node in the second knowledge graph can be associated with a node in the first knowledge graph using the fifth field. Furthermore, a node associated with any of the first group of nodes in the first knowledge graph can be selected from the second group of nodes in the second knowledge graph using the fifth field. Moreover, a pair of nodes can be acquired by selecting a node associated with any of the first group of nodes in the first knowledge graph from the second group of nodes in the second knowledge graph. In addition, a pair of nodes in the first knowledge graph corresponding to a pair of nodes in the second knowledge graph can be found. Furthermore, a pair of nodes including the third node that stores the first element in the fifth field and the fourth node that stores the second element in the fifth field can be acquired from the second knowledge graph to find a pair of nodes including the first node that stores the first element in the fourth field and the second node that stores the second element in the fourth field from the first knowledge graph, for example. In addition, the comparison document that describes the difference between a path connecting the first node and the second node and a path connecting the third node and the fourth node can be generated, for example. Moreover, the relation between elements of the invention in the scope of claims can be compared with the relation between elements described in the prior art document. Furthermore, the first knowledge graph and the second knowledge graph can be compared with each other to generate the comparison document that describes the comparison between a structure described in the scope of claims and a structure described in the prior art document. As a result, a novel information processing system that is highly convenient, useful, or reliable can be provided.

(4) Another embodiment of the present invention is the above information processing system in which the first component is configured to receive a third document and transmit the third document to the third component and is configured to receive and provide the first knowledge graph. The third document describes the scope of claims. The first knowledge graph corresponds to the third document converted into a graph format.

The second component is configured to receive a fourth prompt and transmit a first inference result to the third component. The large language model is configured to generate the first inference result in response to the fourth prompt.

The third component is configured to receive the third document and transmit the fourth prompt to the second component and is configured to receive the first inference result and transmit the first knowledge graph to the first component. The third component includes a third subcomponent.

The third subcomponent is configured to perform natural language processing, is configured to create a first element list, and is configured to share the first element list within the third component. The first element list stores the first words or phrases recognized as elements in the third document by the natural language processing.

The second subcomponent is configured to sequentially select a first pair of elements from the first element list and is configured to create the fourth prompt. The fourth prompt includes a fourth instruction, the first pair of elements, and the third document. The fourth instruction includes a procedure for generating the first inference result from the third document. The first inference result includes an expression for describing a first relation between one of the first pair of elements and the other of the first pair of elements.

The first subcomponent is configured to create first graph data from the first inference result, is configured to add the first graph data to the first knowledge graph, and is configured to share the first knowledge graph within the third component. The first graph data includes a fifth node, a sixth node, and a first edge. The fifth node stores the attribute showing the scope of claims in the first field and stores the one of the first pair of elements in the second field. The sixth node stores the attribute showing the scope of claims in the first field and stores the other of the first pair of elements in the second field. The first edge includes a sixth field, and the sixth field stores the expression for describing the first relation.

In this manner, the first and second elements described in the scope of claims and an expression for describing a second relation between the first element and the second element can be stored in second graph data, for example. Furthermore, the second graph data can be added to the first knowledge graph. Moreover, elements of the invention in the scope of claims and the relation between the elements can be expressed in the form of the first knowledge graph. As a result, a novel information processing system that is highly convenient, useful, or reliable can be provided.

(5) Another embodiment of the present invention is the above information processing system in which the first component is configured to receive a fourth document and a correspondence list and transmit the fourth document and the correspondence list to the third component and is configured to receive and provide the second knowledge graph. The fourth document is the prior art document. The one of the second words or phrases determined to have a correspondence with the one of the first words or phrases is stored in the correspondence list in association with the one of the first words or phrases. The second knowledge graph corresponds to the fourth document converted into a graph format.

The second component is configured to receive a fifth prompt and transmit a second inference result to the third component. The large language model is configured to generate the second inference result in response to the fifth prompt.

The third component is configured to receive the fourth document and the correspondence list and transmit the fifth prompt to the second component and is configured to receive the second inference result and transmit the second knowledge graph to the first component. The third component includes a third subcomponent.

The third subcomponent is configured to perform natural language processing, is configured to create a second element list, and is configured to share the second element list within the third component. The second element list stores the second words or phrases recognized as elements in the fourth document by the natural language processing.

The second subcomponent is configured to sequentially select a second pair of elements from the second element list and is configured to create the fifth prompt. The fifth prompt includes a fifth instruction, the second pair of elements, and the fourth document. The fifth instruction includes a procedure for generating the second inference result from the fourth document. The second inference result includes an expression for describing a third relation between one of the second pair of elements and the other of the second pair of elements.

The first subcomponent is configured to create third graph data from the second inference result, is configured to add the third graph data to the second knowledge graph, and is configured to share the second knowledge graph within the third component. The third graph data includes a seventh node, an eighth node, and a second edge. The seventh node stores the attribute showing the prior art document in the third field and stores the one of the second pair of elements in the fourth field. In the case where the one of the second pair of elements is associated with a fifth element in the correspondence list, the fifth element is stored in the fifth field. In the case where the one of the second pair of elements is associated with no element in the correspondence list, the false value is stored in the fifth field. The eighth node stores the attribute showing the prior art document in the third field and stores the other of the second pair of elements in the fourth field. In the case where the other of the second pair of elements is associated with a sixth element in the correspondence list, the sixth element is stored in the fifth field. In the case where the other of the second pair of elements is associated with no element in the correspondence list, the false value is stored in the fifth field. The second edge includes a seventh field, and the seventh field stores the expression for describing the third relation.

In this manner, the third element and a seventh element described in the prior art document and an expression for describing a fourth relation between the third element and the seventh element can be stored in fourth graph data, for example. Furthermore, the fourth graph data can be added to the second knowledge graph. In the third node where the third element is stored in the fourth field, the first element can be stored in the fifth field in accordance with the correspondence list. In the case where the seventh element is associated with no element in the correspondence list, the false value can be stored in the fifth field of a ninth node where the seventh element is stored in the fourth field. Moreover, elements of the prior art described in the prior art document and the relation between the elements can be expressed in the form of the second knowledge graph. As a result, a novel information processing system that is highly convenient, useful, or reliable can be provided.

(6) One embodiment of the present invention is an information processing system including a first component, a second component, and a third component.

The first component is configured to receive a first knowledge graph and transmit the first knowledge graph to the third component and is configured to receive and provide a first document. The first knowledge graph includes a first group of nodes. Each of the first group of nodes includes a first field, a second field, and a third field. The first field stores an attribute showing a specification. The second field stores one of first words or phrases recognized as an element. The third field stores one of second words or phrases or a false value. The one of the second words or phrases is determined to have a correspondence with the one of the first words or phrases. The first document describes a relation between a first element and a second element. Each of the first element and the second element is included in the first words or phrases.

The second component is configured to transmit the first document to the third component in response to a prompt chain and is configured to perform processing with a large language model. The large language model is configured to generate the first document in response to a first prompt.

The third component is configured to receive the first knowledge graph and share the first knowledge graph within the third component, is configured to execute the prompt chain, and is configured to receive the first document and transmit the first document to the first component. The prompt chain includes the first prompt. The third component includes a first subcomponent and a second subcomponent.

The first subcomponent is configured to acquire a first node and a second node from the first group of nodes. The first node stores the first element in the second field and stores a third element in the third field. The second node stores the second element in the second field and stores a fourth element in the third field. The first subcomponent is configured to search for a first path between the first node and the second node and is configured to share the first path within the third component.

The second subcomponent is configured to create the first prompt. The first prompt includes a first instruction and the first path. The first instruction includes a procedure for generating the first document describing the relation between the first element and the second element using the first path.

In this manner, a pair of nodes including the first node that stores the third element in the third field and the second node that stores the fourth element in the third field can be found from the first knowledge graph, for example. Furthermore, a path connecting the first node and the second node can be found, for example. Moreover, the first document that describes the relation between elements described in the specification in which the subject-matter of the invention is described can be generated. The first document can be generated via graph data extracted from the first knowledge graph, in which case the relation between the elements can be described more accurately. In addition, the basis for the first document can be provided using the first knowledge graph. As a result, a novel information processing system that is highly convenient, useful, or reliable can be provided.

(7) Another embodiment of the present invention is the above information processing system in which the first component is configured to receive a second knowledge graph and transmit the second knowledge graph to the third component and is configured to receive and provide a second document.

The second knowledge graph includes a second group of nodes. Each of the second group of nodes includes a fourth field, a fifth field, and a sixth field. The fourth field stores an attribute showing a prior art document. The fifth field stores one of third words or phrases recognized as an element. The sixth field stores the one of the second words or phrases or the false value. The one of the second words or phrases is determined to have a correspondence with the one of the third words or phrases. The second document describes a relation between a fifth element and a sixth element. Each of the fifth element and the sixth element is included in the third words or phrases.

The second component is configured to transmit the second document to the third component in response to the prompt chain. The large language model is configured to generate the second document in response to a second prompt.

The third component is configured to receive the second knowledge graph and share the second knowledge graph within the third component, is configured to execute the prompt chain, and is configured to receive the second document and transmit the second document to the first component. The prompt chain includes the second prompt.

The first subcomponent is configured to acquire a third node and a fourth node from the second group of nodes. The third node stores the fifth element in the fifth field and stores the third element in the sixth field. The fourth node stores the sixth element in the fifth field and stores the fourth element in the sixth field. The first subcomponent is configured to search for a second path between the third node and the fourth node and is configured to share the second path within the third component.

The second subcomponent is configured to create the second prompt. The second prompt includes a second instruction and the second path. The second instruction includes a procedure for generating the second document describing the relation between the fifth element and the sixth element using the second path.

In this manner, a pair of nodes including the third node that stores the third element in the sixth field and the fourth node that stores the fourth element in the sixth field can be found from the second knowledge graph, for example. Furthermore, a path connecting the third node and the fourth node can be found, for example. Moreover, the second document that describes the relation between elements described in the specification in which the subject-matter of the invention is described can be generated. The second document can be generated via graph data extracted from the second knowledge graph, in which case the relation between the elements can be described more accurately. In addition, the basis for the second document can be provided using the second knowledge graph. As a result, a novel information processing system that is highly convenient, useful, or reliable can be provided.

(8) Another embodiment of the present invention is the above information processing system in which the first component is configured to receive and provide a comparison document. The comparison document describes a difference between the relation between the first element and the second element and the relation between the fifth element and the sixth element.

The second component is configured to transmit the comparison document to the third component in response to the prompt chain. The large language model is configured to generate the comparison document in response to a third prompt.

The third component is configured to execute the prompt chain and is configured to receive the comparison document and transmit the comparison document to the first component. The prompt chain includes the third prompt.

The second subcomponent is configured to create the third prompt. The third prompt includes a third instruction, the first document, and the second document. The third instruction includes a procedure for comparing the first document and the second document to generate the comparison document describing the difference between the relation between the first element and the second element and the relation between the fifth element and the sixth element.

In this manner, a node in the second knowledge graph can be associated with a node in the first knowledge graph using the sixth field. Furthermore, a node associated with any of the first group of nodes in the first knowledge graph can be selected from the second group of nodes in the second knowledge graph using the sixth field. Moreover, a pair of nodes can be acquired by selecting a node associated with any of the first group of nodes in the first knowledge graph from the second group of nodes in the second knowledge graph. In addition, a pair of nodes in the first knowledge graph corresponding to a pair of nodes in the second knowledge graph can be found. Furthermore, a pair of nodes including the third node that stores the third element in the sixth field and the fourth node that stores the fourth element in the sixth field can be acquired from the second knowledge graph to find a pair of nodes including the first node that stores the third element in the third field and the second node that stores the fourth element in the third field from the first knowledge graph, for example. In addition, the comparison document that describes the difference between a path connecting the first node and the second node and a path connecting the third node and the fourth node can be generated, for example. Moreover, the relation between the elements described in the specification in which the subject-matter of the invention is described can be compared with the relation between the elements described in the prior art document. Furthermore, the first knowledge graph and the second knowledge graph can be compared with each other to generate the comparison document that describes the comparison between a structure described in the specification in which the subject-matter of the invention is described and a structure described in the prior art document. As a result, a novel information processing system that is highly convenient, useful, or reliable can be provided.

(9) Another embodiment of the present invention is the above information processing system in which the first component is configured to receive a third document and a correspondence list and transmit the third document and the correspondence list to the third component and is configured to receive and provide the first knowledge graph. The third document is the specification in which a subject-matter of an invention is described. The one of the first words or phrases determined to have a correspondence with the one of the second words or phrases is stored in the correspondence list in association with the one of the second words or phrases. The first knowledge graph corresponds to the third document converted into a graph format.

The second component is configured to receive a fourth prompt and transmit an inference result to the third component. The large language model is configured to generate the inference result in response to the fourth prompt.

The third component is configured to receive the third document and transmit the fourth prompt to the second component and is configured to receive the inference result and transmit the first knowledge graph to the first component. The third component includes a third subcomponent.

The third subcomponent is configured to perform natural language processing, is configured to create an element list, and is configured to share the element list within the third component. The element list stores the first words or phrases recognized as elements in the third document by the natural language processing.

The second subcomponent is configured to sequentially select a pair of elements from the element list and is configured to create the fourth prompt. The fourth prompt includes a fourth instruction, the pair of elements, and the third document. The fourth instruction includes a procedure for generating the inference result from the third document. The inference result includes an expression for describing a first relation between one of the pair of elements and the other of the pair of elements.

The first subcomponent is configured to create first graph data from the inference result, is configured to add the first graph data to the first knowledge graph, and is configured to share the first knowledge graph within the third component. The first graph data includes a fifth node, a sixth node, and an edge. The fifth node stores the attribute showing the specification in the first field and stores the one of the pair of elements in the second field. In the case where the one of the pair of elements is associated with a seventh element in the correspondence list, the seventh element is stored in the third field. In the case where the one of the pair of elements is associated with no element in the correspondence list, the false value is stored in the third field. The sixth node stores the attribute showing the specification in the first field and stores the other of the pair of elements in the second field. In the case where the other of the pair of elements is associated with an eighth element in the correspondence list, the eighth element is stored in the third field. In the case where the other of the pair of elements is associated with no element in the correspondence list, the false value is stored in the third field. The edge includes a seventh field, and the seventh field stores the expression for describing the first relation.

In this manner, the first element and a ninth element described in the specification in which the subject-matter of the invention is described and an expression for describing a second relation between the first element and the ninth element can be stored in second graph data, for example. Furthermore, the second graph data can be added to third knowledge graph. In the first node where the first element is stored in the second field, the third element can be stored in the third field in accordance with the correspondence list. In the case where the ninth element is associated with no element in the correspondence list, the false value can be stored in the third field of a seventh node where the ninth element is stored in the second field. Moreover, elements described in the specification and the relation between the elements can be expressed in the form of the first knowledge graph. As a result, a novel information processing system that is highly convenient, useful, or reliable can be provided.

(10) One embodiment of the present invention is an information processing method including a first phase. The first phase includes first to tenth steps.

In the first step of the first phase, a first component receives a first knowledge graph and a second knowledge graph and transmits the first knowledge graph and the second knowledge graph to a second component.

The first knowledge graph includes a first group of nodes. Each of the first group of nodes includes a first field and a second field. The first field stores an attribute showing a scope of claims. The second field stores one of first words or phrases recognized as an element in the scope of claims.

The second knowledge graph includes a second group of nodes. Each of the second group of nodes includes a third field, a fourth field, and a fifth field. The third field stores an attribute showing a prior art document. The fourth field stores one of second words or phrases recognized as an element. The fifth field stores the one of the first words or phrases or a false value. The one of the first words or phrases is determined to have a correspondence with the one of the second words or phrases.

In the second step of the first phase, the second component receives the first knowledge graph and the second knowledge graph and shares the first knowledge graph and the second knowledge graph within the second component. The second component includes a first subcomponent and a second subcomponent.

In the third step of the first phase, the first subcomponent acquires a first node and a second node from the second group of nodes and acquires a third node and a fourth node from the first group of nodes. The first node stores a first element in the fourth field and stores a second element in the fifth field. The second node stores a third element in the fourth field and stores a fourth element in the fifth field. The third node stores the second element in the second field. The fourth node stores the fourth element in the second field.

In the fourth step of the first phase, the first subcomponent searches for a first path between the third node and the fourth node.

In the fifth step of the first phase, the first subcomponent searches for a second path between the first node and the second node.

In the sixth step of the first phase, the first subcomponent shares the first path and the second path within the second component.

In the seventh step of the first phase, the second component executes a first prompt chain. The first prompt chain includes a first prompt, a second prompt, and a third prompt.

The first prompt includes a first instruction and the first path. The first instruction includes a procedure for generating a first document describing a relation between the second element and the fourth element using the first path.

The second prompt includes a second instruction and the second path. The second instruction includes a procedure for generating a second document describing a relation between the first element and the third element using the second path.

The third prompt includes a third instruction, the first document, and the second document. The third instruction includes a procedure for comparing the first document and the second document to generate a first comparison document describing a difference between the relation between the second element and the fourth element and the relation between the first element and the third element.

In the eighth step of the first phase, a third component transmits the first document, the second document, and the first comparison document to the second component in response to the first prompt chain.

In the ninth step of the first phase, the second component receives the first document, the second document, and the first comparison document and transmits the first document, the second document, and the first comparison document to the first component.

In the tenth step of the first phase, the first component receives and provides the first document, the second document, and the first comparison document.

In this manner, a node in the second knowledge graph can be associated with a node in the first knowledge graph using the fifth field. Furthermore, a node associated with any of the first group of nodes in the first knowledge graph can be selected from the second group of nodes in the second knowledge graph using the fifth field. Moreover, a pair of nodes can be acquired by selecting a node associated with any of the first group of nodes in the first knowledge graph from the second group of nodes in the second knowledge graph. In addition, a pair of nodes in the first knowledge graph corresponding to a pair of nodes in the second knowledge graph can be found. Furthermore, a pair of nodes including the first node that stores the second element in the fifth field and the second node that stores the fourth element in the fifth field can be acquired from the second knowledge graph to find a pair of nodes including the third node that stores the second element in the second field and the fourth node that stores the fourth element in the second field from the first knowledge graph, for example. In addition, the first comparison document that describes the difference between a path connecting the third node and the fourth node and a path connecting the first node and the second node can be generated, for example. Moreover, the relation between elements of the invention in the scope of claims can be compared with the relation between elements described in the prior art document. Furthermore, the first knowledge graph and the second knowledge graph can be compared with each other to generate the first comparison document that describes the comparison between a structure described in the scope of claims and a structure described in the prior art document. As a result, a novel information processing method that is highly convenient, useful, or reliable can be provided.

(11) One embodiment of the present invention is an information processing method including a first phase. The first phase includes first to tenth steps.

In the first step of the first phase, a first component receives a third knowledge graph and a second knowledge graph and transmits the third knowledge graph and the second knowledge graph to a second component.

The third knowledge graph includes a third group of nodes. Each of the third group of nodes includes a sixth field, a seventh field, and an eighth field. The sixth field stores an attribute showing a specification. The seventh field stores one of third words or phrases recognized as an element. The eighth field stores one of first words or phrases or a false value. The one of the first words or phrases is determined to have a correspondence with the one of the third words or phrases.

The second knowledge graph includes a second group of nodes. Each of the second group of nodes includes a third field, a fourth field, and a fifth field. The third field stores an attribute showing a prior art document. The fourth field stores one of second words or phrases recognized as an element. The fifth field stores the one of the first words or phrases or the false value. The one of the first words or phrases is determined to have a correspondence with the one of the second words or phrases.

In the second step of the first phase, the second component receives the third knowledge graph and the second knowledge graph and shares the third knowledge graph and the second knowledge graph within the second component. The second component includes a first subcomponent and a second subcomponent.

In the third step of the first phase, the first subcomponent acquires a first node and a second node from the second group of nodes and acquires a fifth node and a sixth node from the third group of nodes. The first node stores a first element in the fourth field and stores a second element in the fifth field. The second node stores a third element in the fourth field and stores a fourth element in the fifth field. The fifth node stores a fifth element in the seventh field and stores the second element in the eighth field. The sixth node stores a sixth element in the seventh field and stores the fourth element in the eighth field.

In the fourth step of the first phase, the first subcomponent searches for a third path between the fifth node and the sixth node.

In the fifth step of the first phase, the first subcomponent searches for a second path between the first node and the second node.

In the sixth step of the first phase, the first subcomponent shares the third path and the second path within the second component.

In the seventh step of the first phase, the second component executes a second prompt chain. The second prompt chain includes a fourth prompt, a second prompt, and a fifth prompt.

The fourth prompt includes a fourth instruction and the third path. The fourth instruction includes a procedure for generating a third document describing a relation between the fifth element and the sixth element using the third path.

The second prompt includes a second instruction and the second path. The second instruction includes a procedure for generating a second document describing a relation between the first element and the third element using the second path.

The fifth prompt includes a fifth instruction, the third document, and the second document. The fifth instruction includes a procedure for comparing the third document and the second document to generate a second comparison document describing a difference between the relation between the fifth element and the sixth element and the relation between the first element and the third element.

In the eighth step of the first phase, a third component transmits the third document, the second document, and the second comparison document to the second component in response to the second prompt chain.

In the ninth step of the first phase, the second component receives the third document, the second document, and the second comparison document and transmits the third document, the second document, and the second comparison document to the first component.

In the tenth step of the first phase, the first component receives and provides the third document, the second document, and the second comparison document.

In this manner, a node in the second knowledge graph can be associated with a node in the third knowledge graph using the fifth field. Furthermore, a node associated with any of the third group of nodes in the third knowledge graph can be selected from the second group of nodes in the second knowledge graph using the fifth field. Moreover, a pair of nodes can be acquired by selecting a node associated with any of the third group of nodes in the third knowledge graph from the second group of nodes in the second knowledge graph. In addition, a pair of nodes in the third knowledge graph corresponding to a pair of nodes in the second knowledge graph can be found. Furthermore, a pair of nodes including the first node that stores the second element in the fifth field and the second node that stores the fourth element in the fifth field can be acquired from the second knowledge graph to find a pair of nodes including the fifth node that stores the second element in the eighth field and the sixth node that stores the fourth element in the eighth field from the third knowledge graph, for example. In addition, the second comparison document that describes the difference between a path connecting the fifth node and the sixth node and a path connecting the first node and the second node can be generated, for example. Moreover, the relation between the elements described in the specification in which the subject-matter of the invention is described can be compared with the relation between the elements described in the prior art document. Furthermore, the third knowledge graph and the second knowledge graph can be compared with each other to generate the second comparison document that describes the comparison between a structure described in the specification in which the subject-matter of the invention is described and a structure described in the prior art document. As a result, a novel information processing method that is highly convenient, useful, or reliable can be provided.

(12) Another embodiment of the present invention is the information processing method including the first phase and a second phase. The first phase follows the second phase. The second phase includes first to tenth steps.

In the first step of the second phase, the first component receives a fourth document and transmits the fourth document to the second component. The fourth document describes the scope of claims.

In the second step of the second phase, the second component receives the fourth document and shares the fourth document within the second component. The second component includes a third subcomponent.

In the third step of the second phase, the third subcomponent creates a first element list and shares the first element list within the second component. The first element list stores the first words or phrases recognized as elements in the fourth document by natural language processing.

In the fourth step of the second phase, the second subcomponent sequentially selects a first pair of elements from the first element list.

In the fifth step of the second phase, the second subcomponent creates a sixth prompt and transmits the sixth prompt to the third component. The sixth prompt includes a sixth instruction, the first pair of elements, and the fourth document. The sixth instruction includes a procedure for generating a first inference result from the fourth document. The first inference result includes an expression for describing a first relation between one of the first pair of elements and the other of the first pair of elements.

In the sixth step of the second phase, the third component receives the sixth prompt, generates the first inference result using a large language model, and transmits the first inference result to the second component.

In the seventh step of the second phase, the first subcomponent creates first graph data from the first inference result. The first graph data includes a seventh node, an eighth node, and a first edge. The seventh node stores the attribute showing the scope of claims in the first field and stores the one of the first pair of elements in the second field. The eighth node stores the attribute showing the scope of claims in the first field and stores the other of the first pair of elements in the second field. The first edge includes a ninth field, and the ninth field stores the expression for describing the first relation.

In the eighth step of the second phase, the first subcomponent adds the first graph data to the first knowledge graph and shares the first knowledge graph within the second component.

In the ninth step of the second phase, the second component transmits the first knowledge graph to the first component.

In the tenth step of the second phase, the first component receives and provides the first knowledge graph.

In this manner, the second and fourth elements described in the scope of claims and an expression for describing a second relation between the second element and the fourth element can be stored in second graph data, for example. Furthermore, the second graph data can be added to the first knowledge graph. Moreover, elements of the invention in the scope of claims and the relation between the elements can be expressed in the form of the first knowledge graph. As a result, a novel information processing method that is highly convenient, useful, or reliable can be provided.

(13) Another embodiment of the present invention is the information processing method including the first phase and a second phase. The first phase follows the second phase. The second phase includes first to tenth steps.

In the first step of the second phase, the first component receives a fifth document and a correspondence list and transmits the fifth document and the correspondence list to the second component. The fifth document is the specification in which a subject-matter of an invention is described. The one of the third words or phrases determined to have a correspondence with the one of the first words or phrases is stored in the correspondence list in association with the one of the first words or phrases.

In the second step of the second phase, the second component receives the fifth document and the correspondence list and shares the fifth document and the correspondence list within the second component. The second component includes a third subcomponent.

In the third step of the second phase, the third subcomponent creates a second element list and shares the second element list within the second component. The second element list stores the third words or phrases recognized as elements in the fifth document by natural language processing.

In the fourth step of the second phase, the second subcomponent sequentially selects a second pair of elements from the second element list.

In the fifth step of the second phase, the second subcomponent creates a seventh prompt and transmits the seventh prompt to the third component. The seventh prompt includes a seventh instruction, the second pair of elements, and the fifth document. The seventh instruction includes a procedure for generating a second inference result from the fifth document. The second inference result includes an expression for describing a third relation between one of the second pair of elements and the other of the second pair of elements.

In the sixth step of the second phase, the third component receives the seventh prompt, generates the second inference result using a large language model, and transmits the second inference result to the second component.

In the seventh step of the second phase, the first subcomponent creates third graph data from the second inference result. The third graph data includes a ninth node, a tenth node, and a second edge. The ninth node stores the attribute showing the specification in the sixth field and stores the one of the second pair of elements in the seventh field. In the case where the one of the second pair of elements is associated with a seventh element in the correspondence list, the seventh element is stored in the eighth field. In the case where the one of the second pair of elements is associated with no element in the correspondence list, the false value is stored in the eighth field. The tenth node stores the attribute showing the specification in the sixth field and stores the other of the second pair of elements in the seventh field. In the case where the other of the second pair of elements is associated with an eighth element in the correspondence list, the eighth element is stored in the eighth field. In the case where the other of the second pair of elements is associated with no element in the correspondence list, the false value is stored in the eighth field. The second edge includes a tenth field, and the tenth field stores the expression for describing the third relation.

In the eighth step of the second phase, the first subcomponent adds the third graph data to the third knowledge graph and shares the third knowledge graph within the second component.

In the ninth step of the second phase, the second component transmits the third knowledge graph to the first component.

In the tenth step of the second phase, the first component receives and provides the third knowledge graph.

In this manner, the fifth element and a ninth element described in the specification in which the subject-matter of the invention is described and an expression for describing a fourth relation between the fifth element and the ninth element can be stored in fourth graph data, for example. Furthermore, the fourth graph data can be added to fourth knowledge graph. In the fifth node where the seventh element is stored in the fifth field, the second element can be stored in the eighth field in accordance with the correspondence list. In the case where the ninth element is associated with no element in the correspondence list, the false value can be stored in the eighth field of an eleventh node where the ninth element is stored in the seventh field. Moreover, elements described in the specification and the relation between the elements can be expressed in the form of the third knowledge graph. As a result, a novel information processing method that is highly convenient, useful, or reliable can be provided.

(14) Another embodiment of the present invention is the information processing method including the first phase, the second phase, and a third phase. The first phase follows the third phase, and the third phase follows the second phase. The third phase includes first to tenth steps.

In the first step of the third phase, the first component receives a sixth document and the correspondence list and transmits the sixth document and the correspondence list to the second component. The sixth document is the prior art document. The one of the second words or phrases determined to have a correspondence with the one of the first words or phrases is stored in the correspondence list in association with the one of the first words or phrases.

In the second step of the third phase, the second component receives the sixth document and the correspondence list and shares the sixth document and the correspondence list within the second component. The second component includes the third subcomponent.

In the third step of the third phase, the third subcomponent creates a third element list and shares the third element list within the second component. The third element list stores the second words or phrases recognized as elements in the sixth document by the natural language processing.

In the fourth step of the third phase, the second subcomponent sequentially selects a third pair of elements from the third element list.

In the fifth step of the third phase, the second subcomponent creates an eighth prompt and transmits the eighth prompt to the third component. The eighth prompt includes an eighth instruction, the third pair of elements, and the sixth document. The eighth instruction includes a procedure for generating a third inference result from the sixth document. The third inference result includes an expression for describing a fifth relation between one of the third pair of elements and the other of the third pair of elements.

In the sixth step of the third phase, the third component receives the eighth prompt, generates the third inference result using the large language model, and transmits the third inference result to the second component.

In the seventh step of the third phase, the first subcomponent creates fifth graph data from the third inference result. The fifth graph data includes a twelfth node, a thirteenth node, and a third edge. The twelfth node stores the attribute showing the prior art document in the third field and stores the one of the third pair of elements in the fourth field. In the case where the one of the third pair of elements is associated with the seventh element in the correspondence list, the seventh element is stored in the fifth field. In the case where the one of the third pair of elements is associated with no element in the correspondence list, the false value is stored in the fifth field. The thirteenth node stores the attribute showing the prior art document in the third field and stores the other of the third pair of elements in the fourth field. In the case where the other of the third pair of elements is associated with the eighth element in the correspondence list, the eighth element is stored in the fifth field. In the case where the other of the third pair of elements is associated with no element in the correspondence list, the false value is stored in the fifth field. The third edge includes an eleventh field, and the eleventh field stores the expression for describing the fifth relation.

In the eighth step of the third phase, the first subcomponent adds the fifth graph data to the second knowledge graph and shares the second knowledge graph within the second component.

In the ninth step of the third phase, the second component transmits the second knowledge graph to the first component.

In the tenth step of the third phase, the first component receives and provides the second knowledge graph.

In this manner, the first element and a tenth element described in the prior art document and an expression for describing a sixth relation between the first element and the tenth element can be stored in sixth graph data, for example. Furthermore, the sixth graph data can be added to the second knowledge graph. In the first node where the first element is stored in the fourth field, the second element can be stored in the fifth field in accordance with the correspondence list. In the case where the tenth element is associated with no element in the correspondence list, the false value can be stored in the fifth field of a fourteenth node where the tenth element is stored in the fourth field. Moreover, elements of the prior art described in the prior art document and the relation between the elements can be expressed in the form of the second knowledge graph. As a result, a novel information processing method that is highly convenient, useful, or reliable can be provided.

One embodiment of the present invention can provide a novel information processing system that is highly convenient, useful, or reliable. Another embodiment of the present invention can provide a novel information processing method that is highly convenient, useful, or reliable. Another embodiment of the present invention can provide a novel information processing system, a novel information processing method, or a novel semiconductor device.

The description of these effects does not preclude the presence of other effects. One embodiment of the present invention does not necessarily have all of these effects. Other effects will be apparent from and can be derived from the description of the specification, the drawings, the claims, and the like.

### BRIEF DESCRIPTION OF THE DRAWINGS

FIG. 1 illustrates a structure of an information processing system of an embodiment.

FIGS. 2A and 2B each illustrate a structure of a knowledge graph of an embodiment.

FIGS. 3A and 3B each illustrate a structure of information used in an information processing system of an embodiment.

FIGS. 4A to 4D each illustrate a structure of information used in an information processing system of an embodiment.

FIG. 5 illustrates a structure of a component used in an information processing system of an embodiment.

FIGS. 6A and 6B each illustrate a structure of a knowledge graph of an embodiment.

FIGS. 7A and 7B each illustrate a structure of information used in an information processing system of an embodiment.

FIG. 8 illustrates a structure of an information processing system of an embodiment.

FIG. 9 illustrates a structure of a component used in an information processing system of an embodiment.

FIGS. 10A and 10B each illustrate a structure of information used in an information processing system of an embodiment.

FIG. 11 illustrates a structure of information used in an information processing system of an embodiment.

FIGS. 12A and 12B each illustrate a structure of information used in an information processing system of an embodiment.

FIGS. 13A and 13B each illustrate a structure of a knowledge graph of an embodiment.

FIGS. 14A and 14B each illustrate a structure of information used in an information processing system of an embodiment.

FIGS. 15A to 15D each illustrate a structure of information used in an information processing system of an embodiment.

FIG. 16 illustrates a structure of a component used in an information processing system of an embodiment.

FIG. 17 illustrates a structure of an information processing system of an embodiment.

FIGS. 18A and 18B each illustrate a structure of information used in an information processing system of an embodiment.

FIG. 19 illustrates a structure of an information processing device used for an information processing system of an embodiment.

FIG. 20 illustrates an information processing method of an embodiment.

FIG. 21 illustrates an information processing method of an embodiment.

FIG. 22 illustrates an information processing method of an embodiment.

### DETAILED DESCRIPTION OF THE INVENTION

An information processing system of one embodiment of the present invention includes a first component, a second component, and a third component. The first component is configured to receive a first knowledge graph and transmit the first knowledge graph to the third component and is configured to receive and provide a first document. The first knowledge graph includes a first group of nodes. Each of the first group of nodes includes a first field and a second field. The first field stores an attribute showing a scope of claims. The second field stores one of first words or phrases recognized as an element in the scope of claims. The first document describes a relation between a first element and a second element. Each of the first element and the second element is included in the first words or phrases. The second component is configured to transmit the first document to the third component in response to a prompt chain and is configured to perform processing with a large language model. The large language model is configured to generate the first document in response to a first prompt. The third component is configured to receive the first knowledge graph and share the first knowledge graph within the third component, is configured to execute the prompt chain, and is configured to receive the first document and transmit the first document to the first component. The prompt chain includes the first prompt. The third component includes a first subcomponent and a second subcomponent. The first subcomponent is configured to acquire a first node and a second node from the first group of nodes. The first node stores the first element in the second field, and the second node stores the second element in the second field. The first subcomponent is configured to search for a first path between the first node and the second node and is configured to share the first path within the third component. The second subcomponent is configured to create the first prompt. The first prompt includes a first instruction and the first path. The first instruction includes a procedure for generating the first document describing the relation between the first element and the second element using the first path.

In this manner, a pair of nodes including the first node that stores the first element in the second field and the second node that stores the second element in the second field can be found from the first knowledge graph, for example. Furthermore, a path connecting the first node and the second node can be found, for example. Moreover, the first document that describes the relation between elements of an invention in the scope of claims can be generated. The first document can be generated via graph data extracted from the first knowledge graph, in which case the relation between the elements can be described more accurately. In addition, the basis for the first document can be provided using the first knowledge graph. As a result, a novel information processing system that is highly convenient, useful, or reliable can be provided.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. In structures of the invention described below, the same portions or portions having similar functions are denoted by the same reference numerals in different drawings, and the description thereof is not repeated.

Ordinal numbers such as “first” and “second” in this specification and the like are used in order to avoid confusion among components and thus do not limit the number of components or the order of components (e.g., the order of steps or the stacking order of layers). A term without an ordinal number in this specification and the like may be described with an ordinal number in a claim in order to avoid confusion among components. A term with an ordinal number in this specification and the like may be described with a different ordinal number in a claim. A term with an ordinal number in this specification and the like may be described without an ordinal number in a claim.

Although the block diagram in drawings attached to this specification illustrates components classified by their functions in independent blocks, it is difficult to classify actual components by their functions completely, and one component can have a plurality of functions.

### Embodiment 1

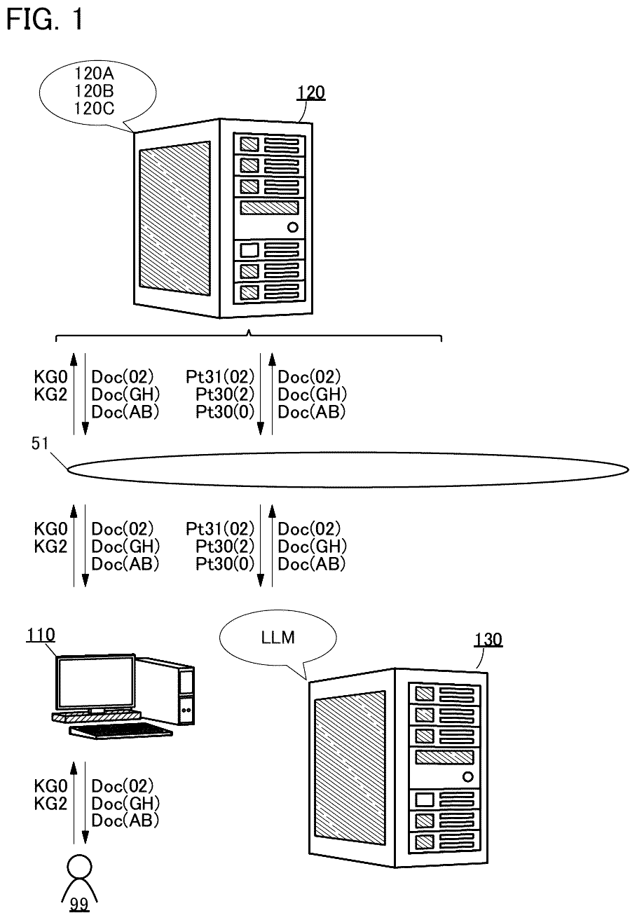

In this embodiment, an information processing system of one embodiment of the present invention will be described with reference to FIG. 1 to FIG. 19.

FIG. 1 illustrates a structure of the information processing system of one embodiment of the present invention.

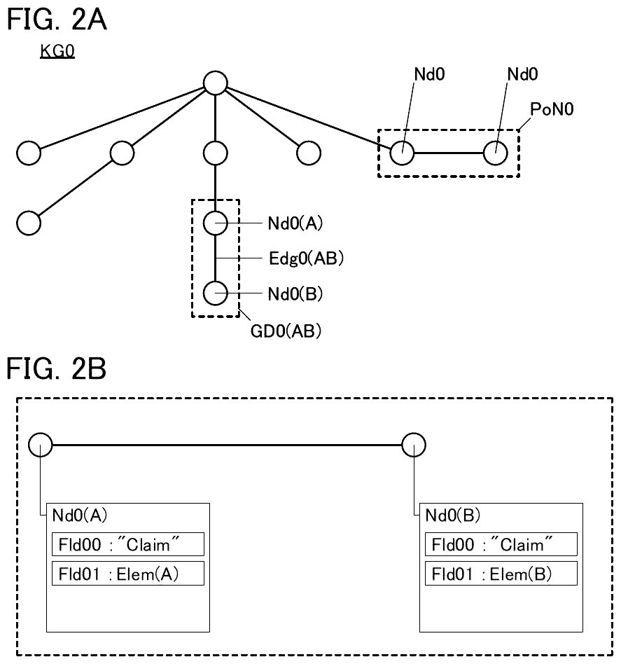

FIG. 2A illustrates a structure of a knowledge graph that can be used in the information processing system of one embodiment of the present invention, and FIG. 2B illustrates part of FIG. 2A.

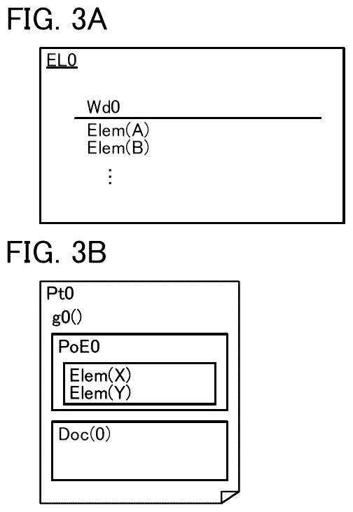

FIG. 3A illustrates a structure of information transmitted and received inside the information processing system of one embodiment of the present invention, and FIG. 3B illustrates a structure of a prompt.

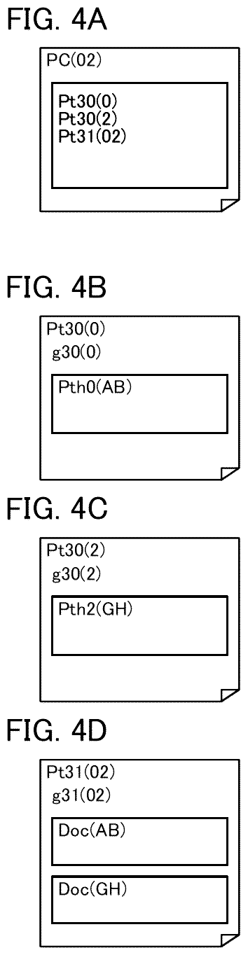

FIG. 4A illustrates a structure of a prompt chain transmitted and received inside the information processing system of one embodiment of the present invention, and FIG. 4B, FIG. 4C, and FIG. 4D each illustrate a structure of a prompt.

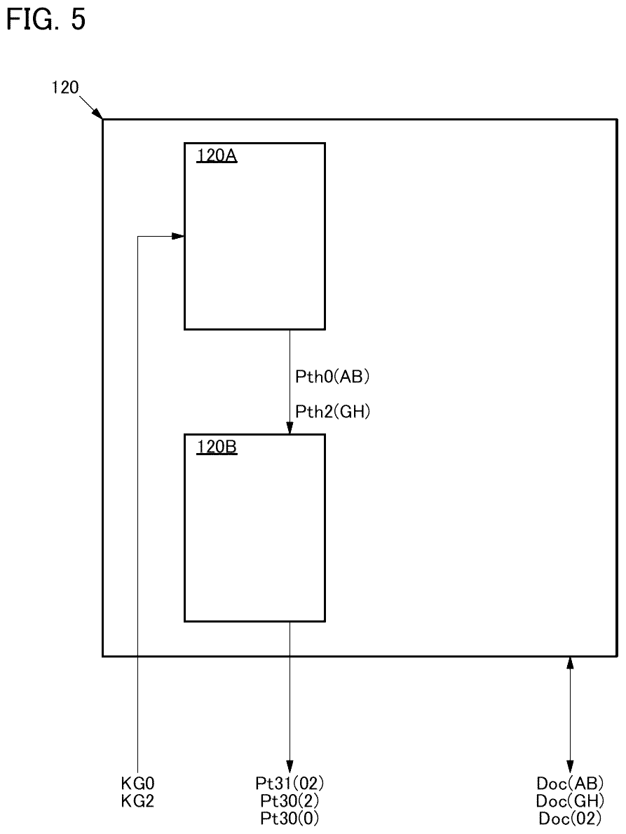

FIG. 5 illustrates a structure of a component used in the information processing system of one embodiment of the present invention.

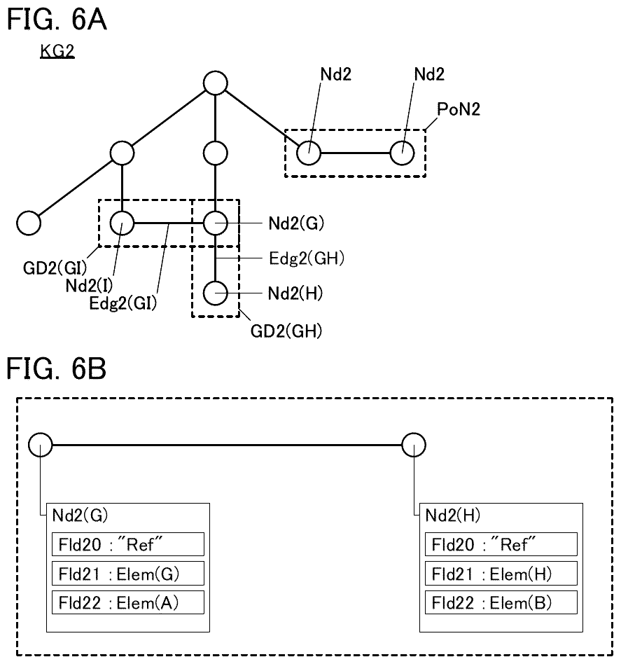

FIG. 6A illustrates a structure of a knowledge graph that can be used in the information processing system of one embodiment of the present invention, and FIG. 6B illustrates part of FIG. 6A.

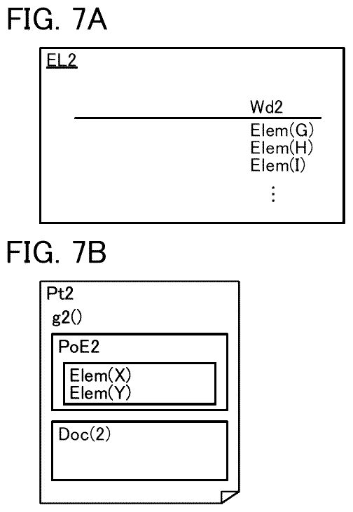

FIG. 7A illustrates a structure of information transmitted and received inside the information processing system of one embodiment of the present invention, and FIG. 7B illustrates a structure of a prompt.

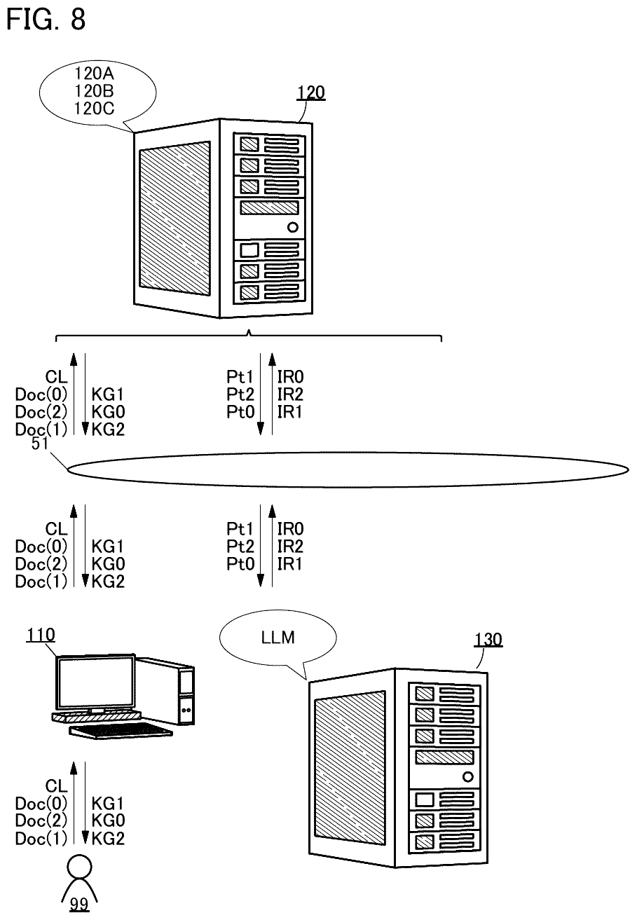

FIG. 8 illustrates a structure of the information processing system of one embodiment of the present invention.

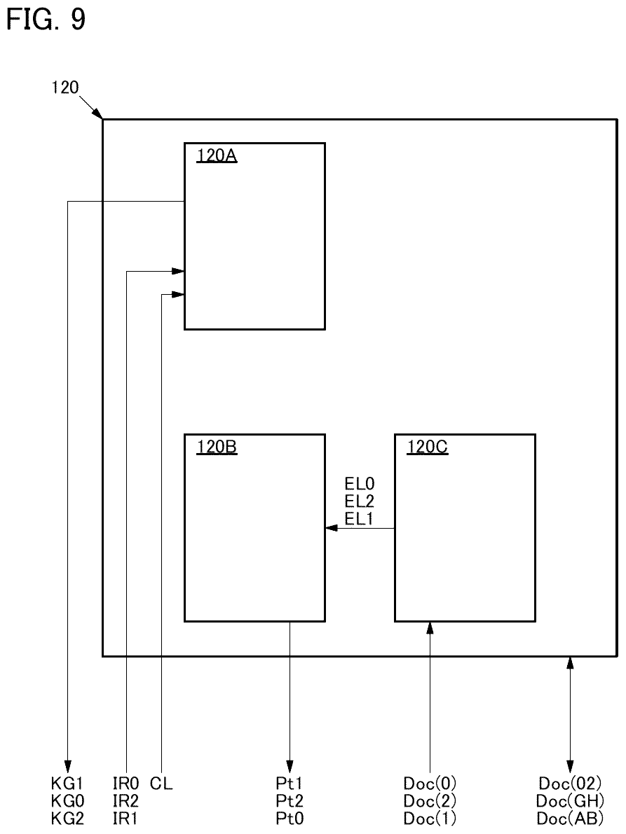

FIG. 9 illustrates a structure of a component used in the information processing system of one embodiment of the present invention.

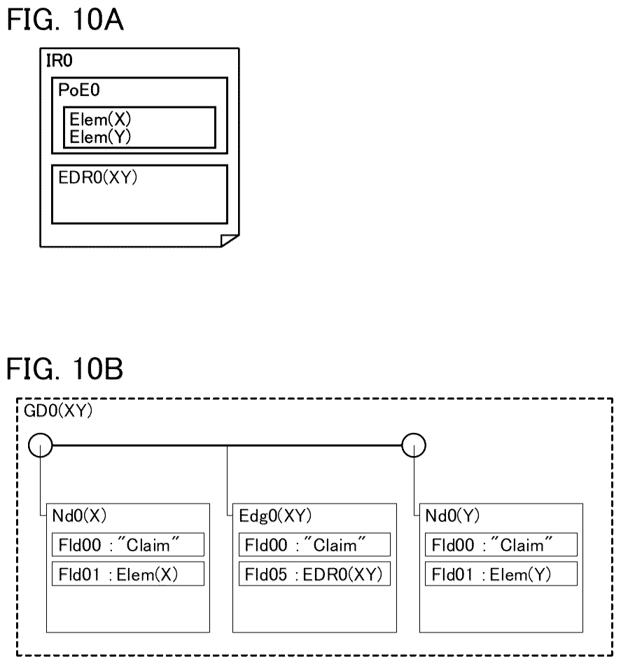

FIG. 10A illustrates a structure of an inference result transmitted and received inside the information processing system of one embodiment of the present invention, and FIG. 10B illustrates a structure of graph data.

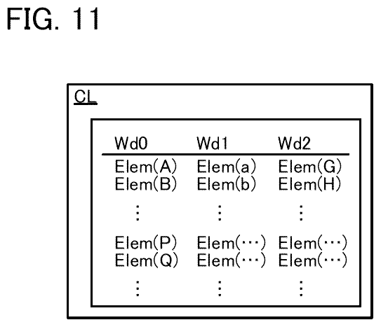

FIG. 11 illustrates a structure of information transmitted and received inside the information processing system of one embodiment of the present invention.

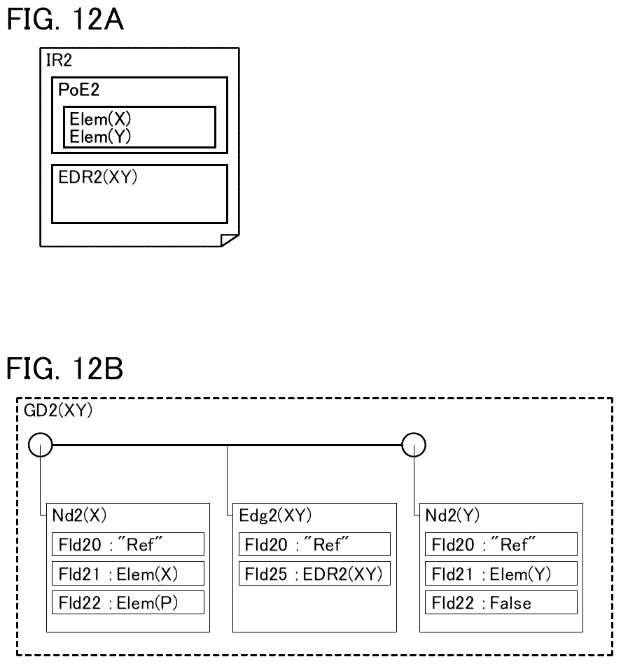

FIG. 12A illustrates a structure of an inference result transmitted and received inside the information processing system of one embodiment of the present invention, and FIG. 12B illustrates a structure of graph data.

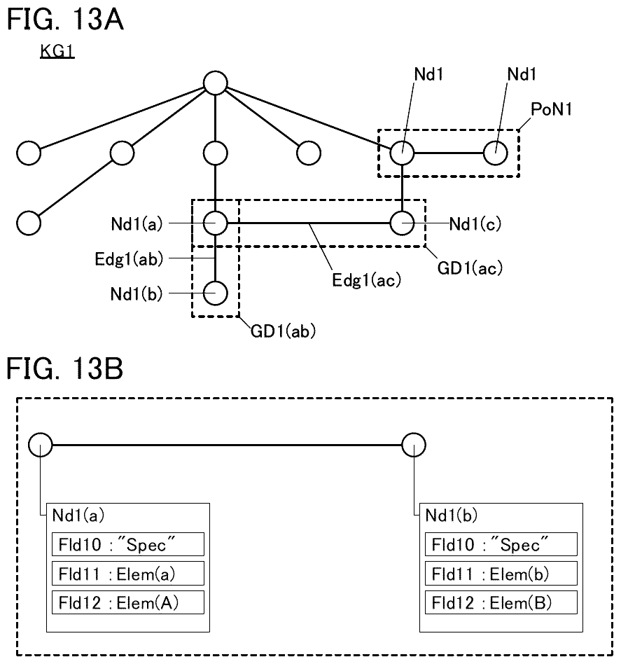

FIG. 13A illustrates a structure of a knowledge graph that can be used in the information processing system of one embodiment of the present invention, and FIG. 13B illustrates part of FIG. 13A.

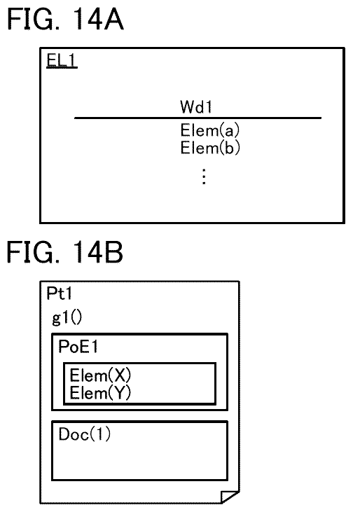

FIG. 14A illustrates a structure of information transmitted and received inside the information processing system of one embodiment of the present invention, and FIG. 14B illustrates a structure of a prompt.

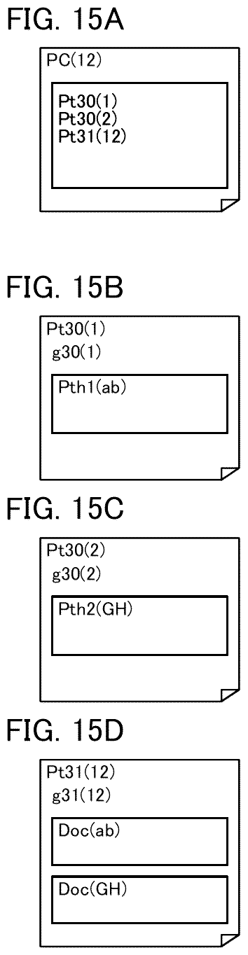

FIG. 15A illustrates a structure of a prompt chain transmitted and received inside the information processing system of one embodiment of the present invention, and FIG. 15B, FIG. 15C, and FIG. 15D each illustrate a structure of a prompt.

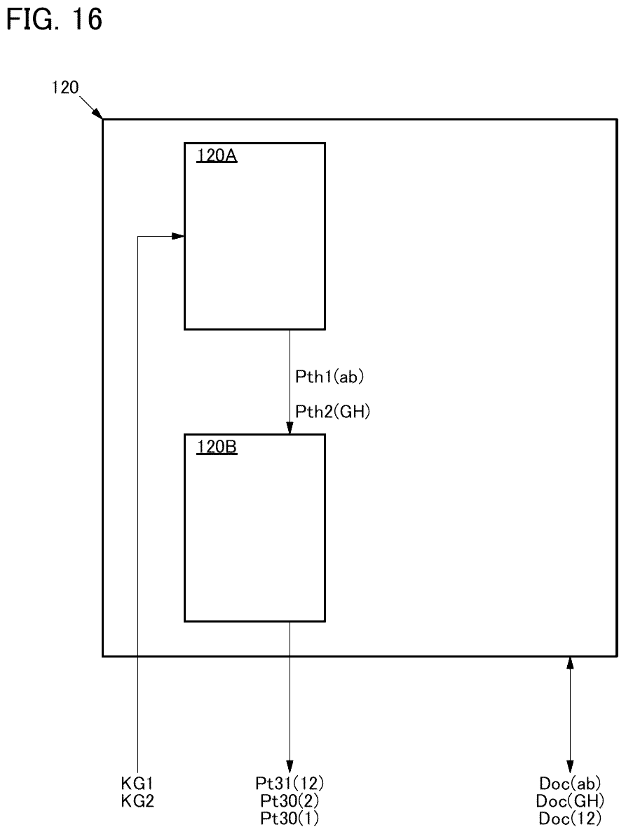

FIG. 16 illustrates a structure of a component used in the information processing system of one embodiment of the present invention.

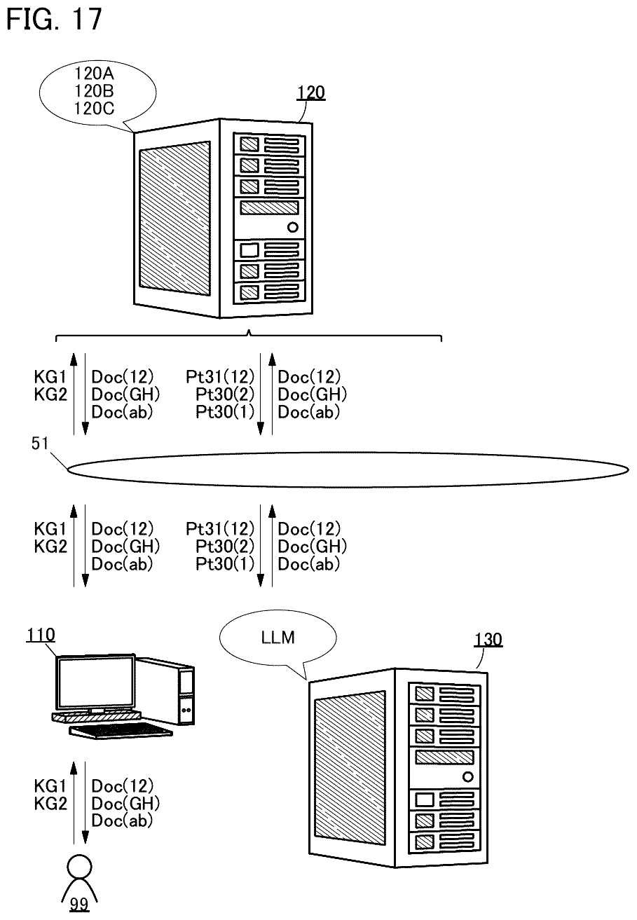

FIG. 17 illustrates a structure of the information processing system of one embodiment of the present invention.

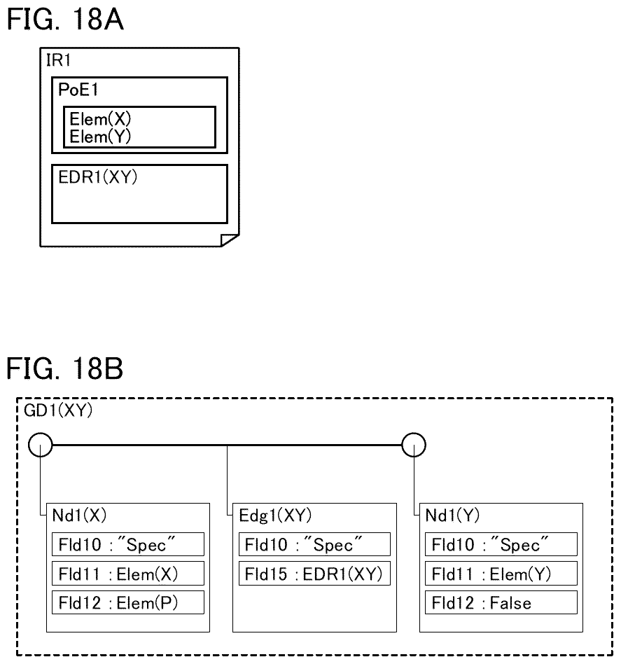

FIG. 18A illustrates a structure of an inference result transmitted and received inside the information processing system of one embodiment of the present invention, and FIG. 18B illustrates a structure of graph data.

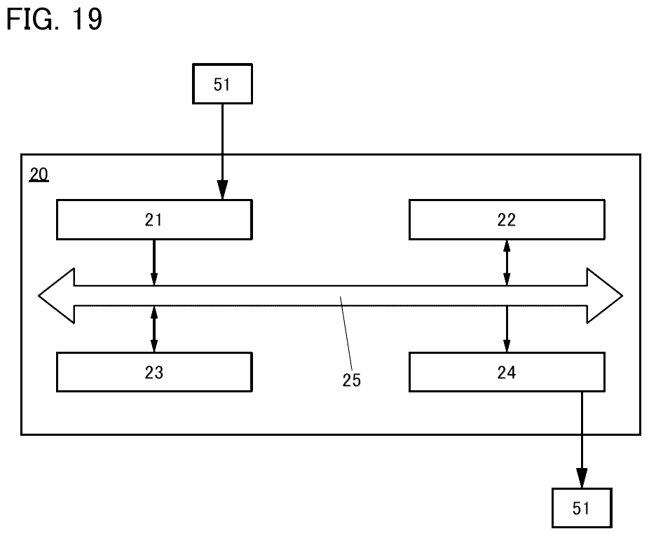

FIG. 19 is a block diagram illustrating a structure of an information processing device that can be used for the information processing system of one embodiment of the present invention.

### Structure Example 1 of Information Processing System

The information processing system described in this embodiment includes a component 110, a component 130, and a component 120 (see FIG. 1).

An information processing device having a function of the component 110, an information processing device having a function of the component 130, and an information processing device having a function of the component 120 each include an arithmetic unit and a communication device, for example. The communication devices in the information processing devices can be connected to one another via a network 51, for example, to construct the information processing system of one embodiment of the present invention.

### Structure Example 1 of Component 110

The component 110 has a function of receiving a knowledge graph KG0 and transmitting the knowledge graph KG0 to the component 120, and a function of receiving a document Doc(AB) and providing the document Doc(AB) to a user 99 of the information processing system, for example. Specifically, the document Doc(AB) is provided to the user 99 of the information processing system via an output device such as a display device, a speaker, a printer, or a memory device.

For example, the user 99 of the information processing system inputs the knowledge graph KG0 to the component 110. Alternatively, the user 99 inputs a command for selecting and transmitting the knowledge graph KG0 stored in a memory device to the component 110, for example. Specifically, the user 99 of the information processing system inputs the knowledge graph KG0 or the command to the component 110 using an input device such as a keyboard, a mouse, or an eye-gaze input device.

### Structure Example of Knowledge Graph KG0

A knowledge graph is graph-form or graph-structured representation, which can express various information in network form. The knowledge graph KG0 includes a group of nodes Nd0 (see FIG. 2A). The group of nodes Nd0 includes, for example, a node Nd0(A) and a node Nd0(B). Each of the group of nodes Nd0 has a field Fld00 and a field Fld01 (see FIG. 2B).

The field Fld00 stores a document attribute, e.g., ‘Scope of Claims (“Claim”)’ of an invention. Thus, information stored in the node Nd0 can be identified as being described in the scope of claims.

The field Fld01 stores one of words or phrases Wd0 recognized as an element of the invention in the scope of claims, for example.

The document Doc(AB) describes the relation between an element Elem(A) and an element Elem(B). Each of the element Elem(A) and the element Elem(B) is included in the words or phrases Wd0 (see FIG. 3A). A document describing the positional relation between the element Elem(A) and the element Elem(B) can be used as the document Doc(AB), for example. Specifically, a sentence “The element Elem(A) is positioned over the element Elem(B).” can be used as the document Doc(AB). Alternatively, a document describing a function of the element Elem(B) with respect to the element Elem(A) can be used as the document Doc(AB), for example. Specifically, a sentence “The element Elem(B) has a function of dividing the element Elem(A).” can be used as the document Doc(AB).

### Structure Example 1 of Component 130

The component 130 has a function of transmitting the document Doc(AB) to the component 120 in response to a prompt chain PC(02) and a function of performing processing with a large language model LLM.

### Structure Example 1 of Large Language Model LLM

The large language model LLM has a function of generating the document Doc(AB) in response to a prompt Pt30(0).

For example, a large language model such as GPT-3 (registered trademark), GPT-3.5, GPT-4 (registered trademark), LaMDA, Llama2, or Llama3 can be used as the large language model LLM.

### Structure Example 1 of Component 120

The component 120 has a function of receiving the knowledge graph KG0 and sharing the knowledge graph KG0 within the component 120.

In addition, the component 120 has a function of executing the prompt chain PC(02) and a function of receiving the document Doc(AB) and transmitting the document Doc(AB) to the component 110. The prompt chain PC(02) includes the prompt Pt30(0) (see FIG. 4A). In the prompt chain, a response to a prompt is used as part of the following prompt and the obtained prompt is transmitted.

The component 120 includes a subcomponent 120A and a subcomponent 120B (see FIG. 5). In this specification, a structure having a single function or a plurality of functions is referred to as a component or a subcomponent for description convenience.

### Structure Example 1 of Subcomponent 120A

The subcomponent 120A has a function of acquiring a pair of nodes PoN0, e.g., the node Nd0(A) and the node Nd0(B), from the group of nodes Nd0 (see FIG. 2A). The node Nd0(A) and the node Nd0(B) are connected to each other by an edge Edg0(AB). Graph data GD0(AB) includes the node Nd0(A), the node Nd0(B), and the edge Edg0(AB).

The user 99 of the information processing system inputs information for selecting the node Nd0(A) and the node Nd0(B) from the knowledge graph KG0 to the component 110, for example. The subcomponent 120A can receive the information via the component 110, thereby acquiring the node Nd0(A) and the node Nd0(B). Alternatively, the subcomponent 120A can select a word or phrase from a correspondence list CL described later to select the node Nd0(A) and the node Nd0(B) from the knowledge graph KG0. For example, all combinations of selecting two words or phrases from the words or phrases Wd0 in the correspondence list CL can be sequentially selected.

In the case where the node Nd0(A) and the node Nd0(B) correspond to a node Nd2(G) and a node Nd2(H) in a knowledge graph KG2 described later, for example, the user 99 of the information processing system inputs information for selecting the nodes Nd2(G) and Nd2(H) from the knowledge graph KG2 to the component 110. The subcomponent 120A can receive the information via the component 110 and use the information as a search query, thereby acquiring the nodes Nd0(A) and Nd0(B). Alternatively, the subcomponent 120A can select a word or phrase from the correspondence list CL described later to select the node Nd2(G) and the node Nd2(H) from the knowledge graph KG2. For example, all combinations of selecting two words or phrases from the words or phrases Wd2 in the correspondence list CL can be sequentially selected.

The node Nd0(A) stores the element Elem(A) in the field Fld01 (see FIG. 2B). The node Nd0(B) stores the element Elem(B) in the field Fld01.

The subcomponent 120A has a function of searching for a path Pth0(AB) between the node Nd0(A) and the node Nd0(B) and a function of sharing the path Pth0(AB) within the component 120. When information stored in a node and an edge related to the path Pth0(AB) is used, for example, the relation between the element Elem(A) and the element Elem(B) can be described in various expressions. In the case where a programming language, Python, is used, the subcomponent 120A can have a function of searching for the path Pth0(AB) using a library such as NetworkX.

### Structure Example 1 of Subcomponent 120B

The subcomponent 120B has a function of creating the prompt Pt30(0).

### Structure Example of Prompt Pt30(0)

The prompt Pt30(0) includes an instruction g30(0) and the path Pth0(AB) (see FIG. 4B). The instruction g30(0) includes a procedure for generating the document Doc(AB) that describes the relation between the element Elem(A) and the element Elem(B) using the path Pth0(AB). For example, text in the next paragraph can be used as the prompt Pt30(0).
“### Input information
Knowledge Graph KG0: {Knowledge graph KG0}
Path Pth0(AB): {Path Pth0(AB)}
### Instruction
Explain the relation between the node Nd0(A) and the node Nd0(B) in the knowledge graph KG0 in consideration of the path Pth0(AB).”

In this manner, a pair of nodes including the node Nd0(A) that stores the element Elem(A) in the field Fld01 and the node Nd0(B) that stores the element Elem(B) in the field Fld01 can be found from the knowledge graph KG0, for example. Furthermore, a path connecting the node Nd0(A) and the node Nd0(B) can be found, for example. Moreover, the document Doc(AB) that describes the relation between elements of the invention in the scope of claims “Claim” can be generated. The document Doc(AB) can be generated via graph data extracted from the knowledge graph KG0, in which case the relation between the elements can be described more accurately. In addition, the basis for the document Doc(AB) can be provided using the knowledge graph KG0. As a result, a novel information processing system that is highly convenient, useful, or reliable can be provided.

### Structure Example 2 of Component 110

The component 110 has a function of receiving the knowledge graph KG2 and transmitting the knowledge graph KG2 to the component 120, and a function of receiving a document Doc(GH) and providing the document Doc(GH) to the user 99 of the information processing system, for example (see FIG. 1). Specifically, the document Doc(GH) is provided to the user 99 of the information processing system via an output device such as a display device, a speaker, a printer, or a memory device.

For example, the user 99 of the information processing system inputs the knowledge graph KG2 to the component 110. Alternatively, the user 99 inputs a command for selecting and transmitting the knowledge graph KG2 stored in a memory device to the component 110, for example. Specifically, the user 99 of the information processing system inputs the knowledge graph KG2 or the command to the component 110 using an input device such as a keyboard, a mouse, or an eye-gaze input device.

### Structure Example 1 of Knowledge Graph KG2

The knowledge graph KG2 includes a group of nodes Nd2 (see FIG. 6A). The group of nodes Nd2 includes, for example, the node Nd2(G), the node Nd2(H), and a node Nd2(I). Each of the group of nodes Nd2 has a field Fld20, a field Fld21, and a field Fld22 (see FIG. 6B).

The field Fld20 stores a document attribute, e.g., ‘Prior Art Document (“Ref”)’.

The field Fld21 stores one of the words or phrases Wd2 recognized as an element.

The field Fld22 stores one of the words or phrases Wd0 or a false value False. The one of the words or phrases Wd0 is determined to have a correspondence with the one of the words or phrases Wd2. In other words, a word or phrase that is determined to have a correspondence with a word or phrase stored in the field Fld21 is stored in the field Fld22. In the case where no word or phrase is determined to have a correspondence with the word or phrase stored in the field Fld21, the false value False is stored in the field Fld22.

The document Doc(GH) describes the relation between an element Elem(G) and an element Elem(H). Each of the element Elem(G) and the element Elem(H) is included in the words or phrases Wd2 (see FIG. 7A).

### Structure Example 2 of Component 130

The component 130 has a function of transmitting the document Doc(GH) to the component 120 in response to the prompt chain PC(02) and a function of performing processing with the large language model LLM.

### Structure Example 2 of Large Language Model LLM

The large language model LLM has a function of generating the document Doc(GH) in response to a prompt Pt30(2).

### Structure Example 2 of Component 120

The component 120 has a function of receiving the knowledge graph KG2 and sharing the knowledge graph KG2 within the component 120.

In addition, the component 120 has a function of executing the prompt chain PC(02) and a function of receiving the document Doc(GH) and transmitting the document Doc(GH) to the component 110. The prompt chain PC(02) includes the prompt Pt30(2) (see FIG. 4A).

### Structure Example 2 of Subcomponent 120A

The subcomponent 120A has a function of acquiring a pair of nodes PoN2, e.g., the node Nd2(G) and the node Nd2(H), from the group of nodes Nd2 (see FIG. 6A). The subcomponent 120A also has a function of acquiring the node Nd2(G) and the node Nd2(I), for example.

The node Nd2(G) and the node Nd2(H) are connected to each other by an edge Edg2(GH). Graph data GD2(GH) includes the node Nd2(G), the node Nd2(H), and the edge Edg2(GH).

The node Nd2(G) and the node Nd2(I) are connected to each other by an edge Edg2(GI). Graph data GD2(GI) includes the node Nd2(G), the node Nd2(I), and the edge Edg2(GI).

The user 99 of the information processing system inputs information for selecting the node Nd2(G) and the node Nd2(H) from the knowledge graph KG2 to the component 110, for example. The subcomponent 120A can receive the information via the component 110, thereby acquiring the node Nd2(G) and the node Nd2(H).

In the case where the node Nd2(G) and the node Nd2(H) correspond to the node Nd0(A) and the node Nd0(B) in the knowledge graph KG0, for example, the user 99 of the information processing system inputs information for selecting the nodes Nd0(A) and Nd0(B) from the knowledge graph KG0 to the component 110. The subcomponent 120A can receive the information via the component 110 and use the information as a search query, thereby acquiring the nodes Nd2(G) and Nd2(H).

The node Nd2(G) stores the element Elem(G) and the element Elem(A) in the field Fld21 and the field Fld22, respectively (see FIG. 6B). The node Nd2(H) stores the element Elem(H) and the element Elem(B) in the field Fld21 and the field Fld22, respectively.

The subcomponent 120A has a function of searching for a path Pth2(GH) between the node Nd2(G) and the node Nd2(H) and a function of sharing the path Pth2(GH) within the component 120.

### Structure Example 2 of Subcomponent 120B

The subcomponent 120B has a function of creating the prompt Pt30(2).

### Structure Example of Prompt Pt30(2)

The prompt Pt30(2) includes an instruction g30(2) and the path Pth2(GH) (see FIG. 4C). The instruction g30(2) includes a procedure for generating the document Doc(GH) that describes the relation between the element Elem(G) and the element Elem(H) using the path Pth2(GH). For example, text in the next paragraph can be used as the prompt Pt30(2).
“### Input information
Knowledge graph KG2: {Knowledge graph KG2}
Path Pth2(GH): {Path Pth2(GH)}
### Instruction
Explain the relation between the node Nd2(G) and the node Nd2(H) in the knowledge graph KG2 in consideration of the path Pth2(GH).”

In this manner, a pair of nodes including the node Nd2(G) that stores the element Elem(A) in the field Fld22 and the node Nd2(H) that stores the element Elem(B) in the field Fld22 can be found from the knowledge graph KG2, for example. Furthermore, a path connecting the node Nd2(G) and the node Nd2(H) can be found, for example. Moreover, the document Doc(GH) that describes the relation between elements described in the prior art document “Ref” can be generated. The document Doc(GH) can be generated via graph data extracted from the knowledge graph KG2, in which case the relation between the elements can be described more accurately. In addition, the basis for the document Doc(GH) can be provided using the knowledge graph KG2. As a result, a novel information processing system that is highly convenient, useful, or reliable can be provided.

### Structure Example 3 of Component 110

The component 110 has a function of receiving a comparison document Doc(02) and providing the comparison document Doc(02) to the user 99 of the information processing system, for example (see FIG. 1). Specifically, the comparison document Doc(02) is provided to the user 99 of the information processing system via an output device such as a display device, a speaker, a printer, or a memory device.

The comparison document Doc(02) describes the difference between the relation between the elements Elem(A) and Elem(B) and the relation between the elements Elem(G) and Elem(H).

### Structure Example 3 of Component 130

The component 130 has a function of transmitting the comparison document Doc(02) to the component 120 in response to the prompt chain PC(02) and a function of performing processing with the large language model LLM.

### Structure Example 3 of Large Language Model LLM

The large language model LLM has a function of generating the comparison document Doc(02) in response to a prompt Pt31(02).

### Structure Example 3 of Component 120

The component 120 has a function of executing the prompt chain PC(02) and a function of receiving the comparison document Doc(02) and transmitting the comparison document Doc(02) to the component 110. The prompt chain PC(02) includes the prompt Pt31(02), and the prompt Pt31(02) includes a response to the previous prompt (see FIG. 4A).

### Structure Example 3 of Subcomponent 120B

The subcomponent 120B has a function of creating the prompt Pt31(02).

### Structure Example of Prompt Pt31(02)

The prompt Pt31(02) includes an instruction g31(02), the document Doc(AB), and the document Doc(GH) (see FIG. 4D).

The instruction g31(02) includes a procedure for comparing the document Doc(AB) and the document Doc(GH) to generate the comparison document Doc(02) that describes the difference between the relation between the elements Elem(A) and Elem(B) and the relation between the elements Elem(G) and Elem(H). For example, text in the next paragraph can be used as the prompt Pt31(02).
“### Input information
Document Doc(AB): {Document Doc(AB)}
Document Doc(GH): {Document Doc(GH)}
### Instruction
Explain the difference between relations between elements using the document Doc(AB) and the document Doc(GH) that describe graph paths.”

In this manner, a node in the knowledge graph KG2 can be associated with a node in the knowledge graph KG0 using the field Fld22. Furthermore, a node associated with any of the group of nodes Nd0 in the knowledge graph KG0 can be selected from the group of nodes Nd2 in the knowledge graph KG2 using the field Fld22. Moreover, a pair of nodes can be acquired by selecting a node associated with any of the group of nodes Nd0 in the knowledge graph KG0 from the group of nodes Nd2 in the knowledge graph KG2. In addition, a pair of nodes in the knowledge graph KG0 corresponding to a pair of nodes in the knowledge graph KG2 can be found. Furthermore, a pair of nodes including the node Nd2(G) that stores the element Elem(A) in the field Fld22 and the node Nd2(H) that stores the element Elem(B) in the field Fld22 can be acquired from the knowledge graph KG2 to find a pair of nodes including the node Nd0(A) that stores the element Elem(A) in the field Fld21 and the node Nd0(B) that stores the element Elem(B) in the field Fld21 from the knowledge graph KG0, for example. In addition, the comparison document Doc(02) that describes the difference between a path connecting the nodes Nd0(A) and Nd0(B) and a path connecting the nodes Nd2(G) and Nd2(H) can be generated, for example. Moreover, the relation between elements of the invention in the scope of claims “Claim” can be compared with the relation between elements described in the prior art document “Ref”. Furthermore, the knowledge graph KG0 and the knowledge graph KG2 can be compared with each other to generate the comparison document Doc(02) that describes the comparison between a structure described in the scope of claims “Claim” and a structure described in the prior art document “Ref”. As a result, a novel information processing system that is highly convenient, useful, or reliable can be provided.

### Structure Example 4 of Component 110

The component 110 has a function of receiving a document Doc(0) and transmitting the document Doc(0) to the component 120, and a function of receiving the knowledge graph KG0 and providing the knowledge graph KG0 to the user 99 of the information processing system, for example (see FIG. 8). Specifically, the knowledge graph KG0 is provided to the user 99 of the information processing system via an output device such as a display device, a speaker, a printer, or a memory device.

The document Doc(0) is a document in which the scope of claims “Claim” is described. The knowledge graph KG0 corresponds to the document Doc(0) converted into a graph format. In other words, information described in the document Doc(0) in a natural language is expressed in the form of the knowledge graph KG0 using a graph format.

### Structure Example 4 of Component 130

The component 130 has a function of receiving a prompt Pt0 and transmitting an inference result IR0 to the component 120 and a function of performing processing with the large language model LLM.

### Structure Example 4 of Large Language Model LLM

The large language model LLM has a function of generating the inference result IR0 in response to the prompt Pt0.

### Structure Example 4 of Component 120

The component 120 has a function of receiving the document Doc(0) and transmitting the prompt Pt0 to the component 130 and a function of receiving the inference result IR0 and transmitting the knowledge graph KG0 to the component 110.

The component 120 includes a subcomponent 120C (see FIG. 9).

### Structure Example 1 of Subcomponent 120C

The subcomponent 120C has a function of performing natural language processing, a function of creating an element list EL0, and a function of sharing the element list EL0 within the component 120. The element list EL0 stores the words or phrases Wd0 recognized as elements in the document Doc(0) by the natural language processing (see FIG. 3A). In other words, the subcomponent 120C segments the document Doc(0), removes an unnecessary word or phrase, and recognizes a word(s) or phrase(s) as the words or phrases Wd0.

The subcomponent 120C can segment the document Doc(0) into morphemes using a morphological analyzer, for example. Alternatively, the subcomponent 120C can segment the document Doc(0) into words. The subcomponent 120C can normalize a word or phrase. The subcomponent 120C can remove a stop word.

### Structure Example 4 of Subcomponent 120B

The subcomponent 120B has a function of sequentially selecting a pair of elements PoE0 from the element list EL0 and a function of creating the prompt Pt0.

For example, when the element list EL0 includes n words or phrases (n is greater than or equal to 2), there are n×(n−1)÷2 possible combinations of the pair of elements PoE0. The subcomponent 120B can select a combination from the possible combinations one by one.

### Structure Example of Prompt Pt0

The prompt Pt0 includes an instruction g0( ), the pair of elements PoE0, and the document Doc(0) (see FIG. 3B).

The instruction g0( ) includes a procedure for generating the inference result IR0 from the document Doc(0). The inference result IR0 includes an expression EDR0(XY) for describing the relation between the pair of elements PoE0 (see FIG. 10A). For example, text in the next paragraph can be used as the prompt Pt0.
“### Input information
Document Doc(0): {Document Doc(0)}
### Instruction
Extract an element Elem(X) and an element Elem(Y) from the document Doc(0) and denote them as PoE0.
Explain the relation between PoE0 and denote it as EDR0(XY).
Use PoE0 as a node and EDR0(XY) as an edge to generate the inference result IR0.”

### Structure Example 3 of Subcomponent 120A

The subcomponent 120A has a function of creating graph data GD0(XY) from the inference result IR0 and a function of adding the graph data GD0(XY) to the knowledge graph KG0. The subcomponent 120A also has a function of sharing the knowledge graph KG0 within the component 120.

### Graph Data GD0(XY)

The graph data GD0(XY) includes a node Nd0(X), a node Nd0(Y), and an edge Edg0(XY) (see FIG. 10B).

The node Nd0(X) stores a document attribute ‘Scope of Claims (“Claim”)’ in the field Fld00 and stores one of the pair of elements PoE0 in the field Fld01. In other words, the node Nd0(X) expresses an element Elem(X) described in the scope of claims “Claim”, and the element Elem(X) is a word or phrase recognized as an element.

The node Nd0(Y) stores a document attribute ‘Scope of Claims (“Claim”)’ in the field Fld00 and stores the other of the pair of elements PoE0 in the field Fld01. In other words, the node Nd0(Y) expresses an element Elem(Y) described in the scope of claims “Claim”, and the element Elem(Y) is a word or phrase recognized as an element.

The edge Edg0(XY) includes a field Fld05, and the field Fld05 stores the expression EDR0(XY) for describing the relation. In other words, the edge Edg0(XY) expresses the relation between the element Elem(X) and the element Elem(Y) described in the scope of claims “Claim” and stores the expression EDR0(XY) for describing the relation.

In the case where the elements Elem(A) and Elem(B) are selected as the pair of elements, for example, the elements Elem(A) and Elem(B) described in the scope of claims “Claim” and an expression EDR0(AB) for describing the relation between the elements Elem(A) and Elem(B) can be stored in the graph data GD0(AB). Furthermore, the graph data GD0(AB) can be added to the knowledge graph KG0. Moreover, elements of the invention in the scope of claims “Claim” and the relation between the elements can be expressed in the form of the knowledge graph KG0. As a result, a novel information processing system that is highly convenient, useful, or reliable can be provided.

### Structure Example 5 of Component 110

The component 110 has a function of receiving a document Doc(2) and the correspondence list CL and transmitting the document Doc(2) and the correspondence list CL to the component 120, and a function of receiving the knowledge graph KG2 and providing the knowledge graph KG2 to the user 99 of the information processing system, for example (see FIG. 8). Specifically, the knowledge graph KG2 is provided to the user 99 of the information processing system via an output device such as a display device, a speaker, a printer, or a memory device.

The document Doc(2) is the prior art document “Ref”. The knowledge graph KG2 corresponds to the document Doc(2) converted into a graph format. In other words, information described in the document Doc(2) in a natural language is expressed in the form of the knowledge graph KG2 using a graph format.

### Structure Example of Correspondence List CL

One of the words or phrases Wd2 that is determined to have a correspondence with one of the words or phrases Wd0 is selected from the words or phrases Wd2 to be stored in the correspondence list CL in association with the one of the words or phrases Wd0 (see FIG. 11). In the case of the examination process of a patent application, for example, a word or phrase used in a scope of claims is presumed by an examiner to have a correspondence with a word or phrase used in a prior art document. Moreover, one of the words or phrases Wd1 that is determined to have a correspondence with one of the words or phrases Wd0 is selected from the words or phrases Wd1 to be stored in the correspondence list CL in association with the one of the words or phrases Wd0. For example, a word or phrase used in a scope of claims has a correspondence with a word or phrase used in a specification.

### Structure Example 5 of Component 130

The component 130 has a function of receiving a prompt Pt2 and transmitting an inference result IR2 to the component 120 and a function of performing processing with the large language model LLM.

### Structure Example 5 of Large Language Model LLM

The large language model LLM has a function of generating the inference result IR2 in response to the prompt Pt2.

### Structure Example 5 of Component 120

The component 120 has a function of receiving the document Doc(2) and the correspondence list CL and transmitting the prompt Pt2 to the component 130 and a function of receiving the inference result IR2 and transmitting the knowledge graph KG2 to the component 110.

The Component 120 Includes the Subcomponent 120C (see FIG. 9).

### Structure Example 2 of Subcomponent 120C

The subcomponent 120C has a function of performing natural language processing, a function of creating an element list EL2, and a function of sharing the element list EL2 within the component 120. The element list EL2 stores the words or phrases Wd2 recognized as elements in the document Doc(2) by the natural language processing (see FIG. 7A). In other words, the subcomponent 120C segments the document Doc(2) into a word(s) or phrase(s). Furthermore, the subcomponent 120C removes an unnecessary word or phrase, and then recognizes the word(s) or phrase(s) as the words or phrases Wd2.

A morphological analyzer can be used as the subcomponent 120C, for example, in which case the subcomponent 120C can segment the document Doc(2) into morphemes.

### Structure Example 5 of Subcomponent 120B

The subcomponent 120B has a function of sequentially selecting a pair of elements PoE2 from the element list EL2 and a function of creating the prompt Pt2.

For example, when the element list EL2 includes n words or phrases (n is greater than or equal to 2), there are n×(n−1)÷2 possible combinations of the pair of elements PoE2. The subcomponent 120B can select a combination from the possible combinations one by one.

### Structure Example of Prompt Pt2

The prompt Pt2 includes an instruction g2( ), the pair of elements PoE2, and the document Doc(2) (see FIG. 7B). The instruction g2( ) includes a procedure for generating the inference result IR2 from the document Doc(2). The inference result IR2 includes an expression EDR2(XY) for describing the relation between the pair of elements PoE2 (see FIG. 12A). For example, text in the next paragraph can be used as the prompt Pt2.
“### Input information
Document Doc(2): {Document Doc(2)}
### Instruction
Extract an element Elem(X) and an element Elem(Y) from the document Doc(2) and denote them as PoE2.
Explain the relation between PoE2 and denote it as EDR2(XY).
Use PoE2 as a node and EDR2(XY) as an edge to generate the inference result IR2.”

### Structure Example 4 of Subcomponent 120A

The subcomponent 120A has a function of creating graph data GD2(XY) from the inference result IR2, a function of adding the graph data GD2(XY) to the knowledge graph KG2, and a function of sharing the knowledge graph KG2 within the component 120.

### Graph Data GD2(XY)

The graph data GD2(XY) includes a node Nd2(X), a node Nd2(Y), and an edge Edg2(XY) (see FIG. 12B).

The node Nd2(X) stores a document attribute ‘Prior Art Document (“Ref”)’ in the field Fld20 and stores one of the pair of elements PoE2 in the field Fld21. In other words, the node Nd2(X) expresses the element Elem(X) described in the prior art document “Ref”, and the element Elem(X) is a word or phrase recognized as an element.

In the case where the one of the pair of elements PoE2 is associated with an element Elem(P) in the correspondence list CL, the element Elem(P) is stored in the field Fld22. In the case where the one of the pair of elements PoE2 is associated with no element in the correspondence list CL, the false value False is stored in the field Fld22. In other words, the node Nd2(X) expresses whether a given element is associated with the element Elem(P) described in the scope of claims “Claim”; in the case where the element is associated with the element Elem(P) described in the scope of claims “Claim”, the node Nd2(X) expresses the element itself.

The node Nd2(Y) stores a document attribute ‘Prior Art Document (“Ref”)’ in the field Fld20 and stores the other of the pair of elements PoE2 in the field Fld21. In other words, the node Nd2(Y) expresses the element Elem(Y) described in the prior art document “Ref”, and the element Elem(Y) is a word or phrase recognized as an element.

In the case where the other of the pair of elements PoE2 is associated with an element Elem(Q) in the correspondence list CL, the element Elem(Q) is stored in the field Fld22. In the case where the other of the pair of elements PoE2 is associated with no element in the correspondence list CL, the false value False is stored in the field Fld22. In other words, the node Nd2(Y) expresses whether a given element is associated with the element Elem(Q) described in the scope of claims “Claim”; in the case where the element is associated with the element Elem(Q) described in the scope of claims “Claim”, the node Nd2(Y) expresses the element itself.

The edge Edg2(XY) includes a field Fld25. The field Fld25 stores the expression EDR2(XY) for describing the relation. In other words, the edge Edg2(XY) expresses the relation between the element Elem(X) and the element Elem(Y) described in the prior art document “Ref” and stores the expression EDR2(XY) for describing the relation.

In the case where the element Elem(G) and an element Elem(I) are selected as the pair of elements, for example, the elements Elem(G) and Elem(I) described in the prior art document “Ref” and an expression EDR2(GI) for describing the relation between the elements Elem(G) and Elem(I) can be stored in the graph data GD2(GI). Furthermore, the graph data GD2(GI) can be added to the knowledge graph KG2. In the node Nd2(G) where the element Elem(G) is stored in the field Fld21, the element Elem(A) can be stored in the field Fld22 in accordance with the correspondence list CL. In the case where the element Elem(I) is associated with no element in the correspondence list CL, the false value False can be stored in the field Fld22 of the node Nd2(I) where the element Elem(I) is stored in the field Fld21. Moreover, elements of the prior art described in the prior art document “Ref” and the relation between the elements can be expressed in the form of the knowledge graph KG2. As a result, a novel information processing system that is highly convenient, useful, or reliable can be provided.

### Structure Example 2 of Information Processing System

The information processing system described in this embodiment includes the component 110, the component 130, and the component 120 (see FIG. 17). Structure example 2 of information processing system is different from Structure example 1 of information processing system in that a knowledge graph KG1 is used instead of the knowledge graph KG0.

### Structure Example 6 of Component 110

The component 110 has a function of receiving the knowledge graph KG1 and transmitting the knowledge graph KG1 to the component 120, and a function of receiving a document Doc(ab) and providing the document Doc(ab) to a user 99 of the information processing system, for example. Specifically, the document Doc(ab) is provided to the user 99 of the information processing system via an output device such as a display device, a speaker, a printer, or a memory device.

For example, the user 99 of the information processing system inputs the knowledge graph KG1 to the component 110. Alternatively, the user 99 inputs a command for selecting and transmitting the knowledge graph KG1 stored in a memory device to the component 110, for example. Specifically, the user 99 of the information processing system inputs the knowledge graph KG1 or the command to the component 110 using an input device such as a keyboard, a mouse, or an eye-gaze input device.

### Structure Example of Knowledge Graph KG1

The knowledge graph KG1 includes a group of nodes Nd1 (see FIG. 13A). The group of nodes Nd1 includes, for example, a node Nd1(a), a node Nd1(b), and a node Nd1(c). Each of the group of nodes Nd1 has a field Fld10, a field Fld11, and a field Fld12 (see FIG. 13B).

The field Fld10 stores a document attribute, e.g., ‘Specification (“Spec”)’.

The field Fld11 stores one of the words or phrases Wd1 recognized as an element.

The field Fld12 has a function of storing one of the words or phrases Wd0 or the false value False. The one of the words or phrases Wd0 is determined to have a correspondence with the one of the words or phrases Wd1. In other words, a word or phrase that is determined to have a correspondence with a word or phrase stored in the field Fld11 is stored in the field Fld12. In the case where no word or phrase is determined to have a correspondence with the word or phrase stored in the field Fld11, the false value False is stored in the field Fld12.

The document Doc(ab) describes the relation between an element Elem(a) and an element Elem(b). Each of the element Elem(a) and the element Elem(b) is included in the words or phrases Wd1 (see FIG. 14A).

### Structure Example 6 of Component 130

The component 130 has a function of transmitting the document Doc(ab) to the component 120 in response to a prompt chain PC(12) and a function of performing processing with the large language model LLM.

### Structure Example 6 of Large Language Model LLM

The large language model LLM has a function of generating the document Doc(ab) in response to a prompt Pt30(1).

### Structure Example 6 of Component 120

The component 120 has a function of receiving the knowledge graph KG1 and sharing the knowledge graph KG1 within the component 120.

In addition, the component 120 has a function of executing the prompt chain PC(12) and a function of receiving the document Doc(ab) and transmitting the document Doc(ab) to the component 110. The prompt chain PC(12) includes the prompt Pt30(1) (see FIG. 15A).

The component 120 includes the subcomponent 120A and the subcomponent 120B (see FIG. 16).

### Structure Example 5 of Subcomponent 120A

The subcomponent 120A has a function of acquiring a pair of nodes PoN1, e.g., the node Nd1(a) and the node Nd1(b), from the group of nodes Nd1 (see FIG. 13A). The subcomponent 120A also has a function of acquiring the node Nd1(a) and the node Nd1(c), for example.

The node Nd1(a) and the node Nd1(b) are connected to each other by an edge Edg1(ab). Graph data GD1(ab) includes the node Nd1(a), the node Nd1(b), and the edge Edg1(ab).

The node Nd1(a) and the node Nd1(c) are connected to each other by an edge Edg1(ac). Graph data GD1(ac) includes the node Nd1(a), the node Nd1(c), and the edge Edg1(ac).

The user 99 of the information processing system inputs information for selecting the node Nd1(a) and the node Nd1(b) from the knowledge graph KG1 to the component 110, for example. The subcomponent 120A can receive the information via the component 110, thereby acquiring the node Nd1(a) and the node Nd1(b).

In the case where the node Nd1(a) and the node Nd1(b) correspond to the node Nd2(G) and the node Nd2(H) in the knowledge graph KG2 described later, for example, the user 99 of the information processing system inputs information for selecting the nodes Nd2(G) and Nd2(H) from the knowledge graph KG2 to the component 110. The subcomponent 120A can receive the information via the component 110 and use the information as a search query, thereby acquiring the nodes Nd1(a) and Nd1(b).

The node Nd1(a) stores the element Elem(a) and the element Elem(A) in the field Fld11 and the field Fld12, respectively (see FIG. 13B). The node Nd1(b) stores the element Elem(b) and the element Elem(B) in the field Fld11 and the field Fld12, respectively.

The subcomponent 120A has a function of searching for a path Pth1(ab) between the node Nd1(a) and the node Nd1(b) and a function of sharing the path Pth1(ab) within the component 120.

### Structure Example 6 of Subcomponent 120B

The subcomponent 120B has a function of creating the prompt Pt30(1).

### Structure Example of Prompt Pt30(1)

The prompt Pt30(1) includes an instruction g30(1) and the path Pth1(ab) (see FIG. 15B). The instruction g30(1) includes a procedure for generating the document Doc(ab) that describes the relation between the element Elem(a) and the element Elem(b) using the path Pth1(ab). For example, text in the next paragraph can be used as the prompt Pt30(1).
“### Input information
Knowledge graph KG1: {Knowledge graph KG1}
Path Pth1(ab): {Path Pth1(ab)}
### Instruction
Explain the relation between the node Nd1(a) and the node Nd1(b) in the knowledge graph KG1 in consideration of the path Pth1(ab).”

In this manner, a pair of nodes including the node Nd1(a) that stores the element Elem(A) in the field Fld12 and the node Nd1(b) that stores the element Elem(B) in the field Fld12 can be found from the knowledge graph KG1, for example. Furthermore, a path connecting the node Nd1(a) and the node Nd1(b) can be found, for example. Moreover, the document Doc(ab) that describes the relation between elements described in the specification “Spec” in which the subject-matter of the invention is described can be generated. The document Doc(ab) can be generated via graph data extracted from the knowledge graph KG1, in which case the relation between the elements can be described more accurately. In addition, the basis for the document Doc(ab) can be provided using the knowledge graph KG1. As a result, a novel information processing system that is highly convenient, useful, or reliable can be provided.

### Structure Example 7 of Component 110

The component 110 has a function of receiving the knowledge graph KG2 and transmitting the knowledge graph KG2 to the component 120, and a function of receiving the document Doc(GH) and providing the document Doc(GH) to the user 99 of the information processing system, for example (see FIG. 17). Specifically, the document Doc(GH) is provided to the user 99 of the information processing system via an output device such as a display device, a speaker, a printer, or a memory device.

### Structure Example 2 of Knowledge Graph KG2

The knowledge graph KG2 includes the group of nodes Nd2 (see FIG. 6A). Each of the group of nodes Nd2 has the field Fld20, the field Fld21, and the field Fld22 (see FIG. 6B).

The field Fld20 stores a document attribute, e.g., ‘Prior Art Document (“Ref”)’.

The field Fld21 stores one of the words or phrases Wd2 recognized as an element.

The field Fld22 stores one of the words or phrases Wd0 or the false value False. The one of the words or phrases Wd0 is determined to have a correspondence with the one of the words or phrases Wd2.

The document Doc(GH) describes the relation between the element Elem(G) and the element Elem(H). Each of the element Elem(G) and the element Elem(H) is included in the words or phrases Wd2 (see FIG. 7A).

### Structure Example 7 of Component 130

The component 130 has a function of transmitting the document Doc(GH) to the component 120 in response to the prompt chain PC(12) and a function of performing processing with the large language model LLM.

### Structure Example 7 of Large Language Model LLM

The large language model LLM has a function of generating the document Doc(GH) in response to the prompt Pt30(2).

### Structure Example 7 of Component 120

The component 120 has a function of receiving the knowledge graph KG2 and sharing the knowledge graph KG2 within the component 120.

In addition, the component 120 has a function of executing the prompt chain PC(12) and a function of receiving the document Doc(GH) and transmitting the document Doc(GH) to the component 110. The prompt chain PC(12) includes the prompt Pt30(2) (see FIG. 15A).

### Structure Example 6 of Subcomponent 120A

The subcomponent 120A has a function of acquiring a pair of nodes, e.g., the node Nd2(G) and the node Nd2(H), from the group of nodes Nd2.

The node Nd2(G) stores the element Elem(G) and the element Elem(A) in the field Fld21 and the field Fld22, respectively (see FIG. 6B). The node Nd2(H) stores the element Elem(H) and the element Elem(B) in the field Fld21 and the field Fld22, respectively.

The subcomponent 120A has a function of searching for the path Pth2(GH) between the node Nd2(G) and the node Nd2(H) and a function of sharing the path Pth2(GH) within the component 120.

### Structure Example 7 of Subcomponent 120B

The subcomponent 120B has a function of creating the prompt Pt30(2).

### Structure Example of Prompt Pt30(2)

The prompt Pt30(2) includes the instruction g30(2) and the path Pth2(GH) (see FIG. 15C). The instruction g30(2) includes a procedure for generating the document Doc(GH) that describes the relation between the element Elem(G) and the element Elem(H) using the path Pth2(GH). For example, text in the next paragraph can be used as the prompt Pt30(2).
“### Input information
Knowledge graph KG2: {Knowledge graph KG2}
Path Pth2(GH): {Path Pth2(GH)}
### Instruction
Explain the relation between the node Nd2(G) and the node Nd2(H) in the knowledge graph KG2 in consideration of the path Pth2(GH).”

In this manner, a pair of nodes including the node Nd2(G) that stores the element Elem(A) in the field Fld22 and the node Nd2(H) that stores the element Elem(B) in the field Fld22 can be found from the knowledge graph KG2, for example. Furthermore, a path connecting the node Nd2(G) and the node Nd2(H) can be found, for example. Moreover, the document Doc(GH) that describes the relation between elements described in the specification “Spec” in which the subject-matter of the invention is described can be generated. The document Doc(GH) can be generated via graph data extracted from the knowledge graph KG2, in which case the relation between the elements can be described more accurately. In addition, the basis for the document Doc(GH) can be provided using the knowledge graph KG2. As a result, a novel information processing system that is highly convenient, useful, or reliable can be provided.

### Structure Example 8 of Component 110

The component 110 has a function of receiving a comparison document Doc(12) and providing the comparison document Doc(12) to the user 99 of the information processing system, for example (see FIG. 17). Specifically, the comparison document Doc(12) is provided to the user 99 of the information processing system via an output device such as a display device, a speaker, a printer, or a memory device.

The comparison document Doc(12) describes the difference between the relation between the elements Elem(a) and Elem(b) and the relation between the elements Elem(G) and Elem(H).

### Structure Example 8 of Component 130

The component 130 has a function of transmitting the comparison document Doc(12) to the component 120 in response to the prompt chain PC(12) and a function of performing processing with the large language model LLM.

### Structure Example 8 of Large Language Model LLM

The large language model LLM has a function of generating the comparison document Doc(12) in response to a prompt Pt31(12).

### Structure Example 8 of Component 120

The component 120 has a function of executing the prompt chain PC(12) and a function of receiving the comparison document Doc(12) and transmitting the comparison document Doc(12) to the component 110. The prompt chain PC(12) includes the prompt Pt31(12), and the prompt Pt31(12) includes a response to the previous prompt (see FIG. 15A).

### Structure Example 8 of Subcomponent 120B

The subcomponent 120B has a function of creating the prompt Pt31(12).

### Structure Example of Prompt Pt31(12)

The prompt Pt31(12) includes an instruction g31(12), the document Doc(ab), and the document Doc(GH) (see FIG. 15D).

The instruction g31(12) includes a procedure for comparing the document Doc(ab) and the document Doc(GH) to generate the comparison document Doc(12) that describes the difference between the relation between the elements Elem(a) and Elem(b) and the relation between the elements Elem(G) and Elem(H). For example, text in the next paragraph can be used as the prompt Pt31(12).
“### Input information
Document Doc(ab): {Document Doc(ab)}
Document Doc(GH): {Document Doc(GH)}
### Instruction
Explain the difference between relations between elements using the document Doc(ab) and the document Doc(GH) that describe graph paths.”

In this manner, a node in the knowledge graph KG2 can be associated with a node in the knowledge graph KG1 using the field Fld22. Furthermore, a node associated with any of the group of nodes Nd1 in the knowledge graph KG1 can be selected from the group of nodes Nd2 in the knowledge graph KG2 using the field Fld22. Moreover, a pair of nodes can be acquired by selecting a node associated with any of the group of nodes Nd1 in the knowledge graph KG1 from the group of nodes Nd2 in the knowledge graph KG2. In addition, a pair of nodes in the knowledge graph KG1 corresponding to a pair of nodes in the knowledge graph KG2 can be found. Furthermore, a pair of nodes including the node Nd2(G) that stores the element Elem(A) in the field Fld22 and the node Nd2(H) that stores the element Elem(B) in the field Fld22 can be acquired from the knowledge graph KG2 to find a pair of nodes including the node Nd1(a) that stores the element Elem(A) in the field Fld12 and the node Nd1(b) that stores the element Elem(B) in the field Fld12 from the knowledge graph KG1, for example. In addition, the comparison document Doc(12) that describes the difference between a path connecting the nodes Nd1(a) and Nd1(b) and a path connecting the nodes Nd2(G) and Nd2(H) can be generated, for example. Moreover, the relation between elements described in the specification “Spec” in which the subject-matter of the invention is described can be compared with the relation between elements described in the prior art document “Ref”. Furthermore, the knowledge graph KG1 and the knowledge graph KG2 can be compared with each other to generate the comparison document Doc(12) that describes the comparison between a structure described in the specification “Spec” in which the subject-matter of the invention is described and a structure described in the prior art document “Ref”. As a result, a novel information processing system that is highly convenient, useful, or reliable can be provided.

### Structure Example 9 of Component 110

The component 110 has a function of receiving a document Doc(1) and the correspondence list CL and transmitting the document Doc(1) and the correspondence list CL to the component 120, and a function of receiving the knowledge graph KG1 and providing the knowledge graph KG1 to the user 99 of the information processing system, for example (see FIG. 8). Specifically, the knowledge graph KG1 is provided to the user 99 of the information processing system via an output device such as a display device, a speaker, a printer, or a memory device.

The document Doc(1) is the specification “Spec” in which the subject-matter of the invention is described. One of the words or phrases Wd1 that is determined to have a correspondence with one of the words or phrases Wd0 is stored in the correspondence list CL in association with the one of the words or phrases Wd0. The knowledge graph KG1 corresponds to the document Doc(1) converted into a graph format. In other words, information described in the document Doc(1) in a natural language is expressed in the form of the knowledge graph KG1 using a graph format.

### Structure Example 9 of Component 130

The component 130 has a function of receiving a prompt Pt1 and transmitting an inference result IR1 to the component 120 and a function of performing processing with the large language model LLM.

### Structure Example 9 of Large Language Model LLM

The large language model LLM has a function of generating the inference result IR1 in response to the prompt Pt1.

### Structure Example 9 of Component 120

The component 120 has a function of receiving the document Doc(1) and transmitting the prompt Pt1 to the component 130 and a function of receiving the inference result IR1 and transmitting the knowledge graph KG1 to the component 110.

The component 120 includes the subcomponent 120C (see FIG. 9).

### Structure Example 7 of Subcomponent 120C

The subcomponent 120C has a function of performing natural language processing, a function of creating an element list EL1, and a function of sharing the element list EL1 within the component 120. The element list EL1 stores the words or phrases Wd1 recognized as elements in the document Doc(1) by the natural language processing (see FIG. 14A). In other words, the subcomponent 120C segments the document Doc(1), removes an unnecessary word or phrase, and recognizes a word(s) or phrase(s) as the words or phrases Wd1.

The subcomponent 120C can segment the document Doc(1) into morphemes using a morphological analyzer, for example. Alternatively, the subcomponent 120C can segment the document Doc(1) into words. The subcomponent 120C can normalize a word or phrase. The subcomponent 120C can remove a stop word.

### Structure Example 9 of Subcomponent 120B

The subcomponent 120B has a function of sequentially selecting a pair of elements PoE1 from the element list EL1 and a function of creating the prompt Pt1.

For example, when the element list EL1 includes n words or phrases (n is greater than or equal to 2), there are n×(n−1)÷2 possible combinations of the pair of elements PoE1. The subcomponent 120B can select a combination from the possible combinations one by one.

### Structure Example of Prompt Pt1

The prompt Pt1 includes an instruction g1( ), the pair of elements PoE1, and the document Doc(1) (see FIG. 14B).

The instruction g1( ) includes a procedure for generating the inference result IR1 from the document Doc(1). The inference result IR1 includes an expression EDR1(XY) for describing the relation between the pair of elements PoE1 (see FIG. 18A). For example, text in the next paragraph can be used as the prompt Pt1.
“### Input information
Document Doc(1): {Document Doc(1)}
### Instruction
Extract an element Elem(X) and an element Elem(Y) from the document Doc(1) and denote them as PoE1.
Explain the relation between PoE1 and denote it as EDR2(XY).
Use PoE1 as a node and EDR2(XY) as an edge to generate the inference result IR1.”

### Structure Example 8 of Subcomponent 120A

The subcomponent 120A has a function of creating graph data GD1(XY) from the inference result IR1, a function of adding the graph data GD1(XY) to the knowledge graph KG1, and a function of sharing the knowledge graph KG1 within the component 120.

### Graph Data GD1(XY)

The graph data GD1(XY) includes a node Nd1(X), a node Nd1(Y), and an edge Edg1(XY) (see FIG. 18B).

The node Nd1(X) stores a document attribute ‘Specification (“Spec”)’ in the field Fld10 and stores one of the pair of elements PoE1 in the field Fld11. In other words, the node Nd1(X) expresses the element Elem(X) described in the specification “Spec”, and the element Elem(X) is a word or phrase recognized as an element.

In the case where the one of the pair of elements PoE1 is associated with the element Elem(P) in the correspondence list CL, the element Elem(P) is stored in the field Fld12. In the case where the one of the pair of elements PoE1 is associated with no element in the correspondence list CL, the false value False is stored in the field Fld12. In other words, the node Nd1(X) expresses whether a given element is associated with the element Elem(P) described in the scope of claims “Claim”; in the case where the element is associated with the element Elem(P) described in the scope of claims “Claim”, the node Nd1(X) expresses the element itself.

The node Nd1(Y) stores a document attribute ‘Specification (“Spec”)’ in the field Fld10 and stores the other of the pair of elements PoE1 in the field Fld11. In other words, the node Nd1(Y) expresses the element Elem(Y) described in the specification “Spec”, and the element Elem(Y) is a word or phrase recognized as an element.

In the case where the other of the pair of elements PoE1 is associated with the element Elem(Q) in the correspondence list CL, the element Elem(Q) is stored in the field Fld12. In the case where the other of the pair of elements PoE1 is associated with no element in the correspondence list CL, the false value False is stored in the field Fld12. In other words, the node Nd1(Y) expresses whether a given element is associated with the element Elem(Q) described in the scope of claims “Claim”; in the case where the element is associated with the element Elem(Q) described in the scope of claims “Claim”, the node Nd1(Y) expresses the element itself.

The edge Edg1(XY) includes a field Fld15. The field Fld15 stores the expression EDR1(XY) for describing the relation. In other words, the edge Edg1(XY) expresses the relation between the element Elem(X) and the element Elem(Y) described in the specification “Spec” and stores the expression EDR1(XY) for describing the relation.

In the case where the element Elem(a) and an element Elem(c) are selected as the pair of elements, for example, the elements Elem(a) and Elem(c) described in the specification “Spec” in which the subject-matter of the invention is described and an expression EDR1(ac) for describing the relation between the elements Elem(a) and Elem(c) can be stored in the graph data GD1(ac). Furthermore, the graph data GD1(ac) can be added to the knowledge graph KG1(ac). In the node Nd1(a) where the element Elem(a) is stored in the field Fld11, the element Elem(A) can be stored in the field Fld12 in accordance with the correspondence list CL. In the case where the element Elem(c) is associated with no element in the correspondence list CL, the false value False can be stored in the field Fld12 of the node Nd1(c) where the element Elem(c) is stored in the field Fld11. Moreover, elements of the invention described in the specification “Spec” and the relation between the elements can be expressed in the form of the knowledge graph KG1. As a result, a novel information processing system that is highly convenient, useful, or reliable can be provided.

### Configuration Example of Information Processing Device

An information processing device 20 that can be used for the information processing system of one embodiment of the present invention includes, for example, an input unit 21, a storage unit 22, a processing unit 23, an output unit 24, and a transmission path 25 (see FIG. 19).

Although the block diagram in drawings attached to this specification illustrates components classified by their functions in independent blocks, it is difficult to classify actual components by their functions completely, and one component can have a plurality of functions. For example, part of the processing unit 23 functions as the input unit 21 in some cases. In addition, one function can be involved in a plurality of components. For example, processing performed in the processing unit 23 is sometimes executed by a different information processing device depending on the processing.

### Input Unit 21

The input unit 21 can receive data from the outside of the information processing device. For example, the input unit 21 receives data via the network 51. Specifically, a device such as a personal computer having a communication port or a communication function can be used.

The input unit 21 supplies the received data to one or both of the storage unit 22 and the processing unit 23 via the transmission path 25.

### Storage Unit 22

The storage unit 22 has a function of storing a program to be executed by the processing unit 23. The storage unit 22 can also have a function of storing data generated by the processing unit 23 (e.g., an arithmetic operation result, an analysis result, or an inference result), data received by the input unit 21, and the like.

The storage unit 22 can include a database. The information processing device can include a database in addition to the storage unit 22. The information processing device can have a function of extracting data from a database outside the storage unit 22, the information processing device, or the data processing system. The information processing device can have a function of extracting data from both of its own database and an external database.

One or both of a storage and a file server can be used as the storage unit 22. In addition, a database in which a path of a file stored in the file server is recorded can be used as the storage unit 22.

The storage unit 22 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The storage unit 22 can include at least one of a NOSRAM (registered trademark) and a DOSRAM (registered trademark). The storage unit 22 can include a storage media drive. Examples of the storage media drive include a hard disk drive (HDD) and a solid state drive (SSD).

Note that the NOSRAM is an abbreviation for “nonvolatile oxide semiconductor random access memory (RAM)”. The NOSRAM refers to a memory in which a 2-transistor (2T) or 3-transistor (3T) gain cell is used as a memory cell and the transistors include a metal oxide in their channel formation regions (such transistors are also referred to as OS transistors). An OS transistor has an extremely low current that flows between a source and a drain in an off state, that is, an extremely low leakage current. The NOSRAM retains electric charge corresponding to data in memory cells by utilizing the characteristics of an extremely low leakage current, thereby capable of being used as a nonvolatile memory. The NOSRAM is capable of reading retained data without destruction (non-destructive reading), and thus is especially suitable for arithmetic processing in which only data reading operations are repeated many times. The NOSRAM can have large data capacity when stacked in layers, and thus, a semiconductor device in which the NOSRAM is used for a large-scale cache memory, a large-scale main memory, or a large-scale storage memory can have higher performance.

The DOSRAM is an abbreviation for “dynamic oxide semiconductor RAM” and refers to a RAM including a one-transistor (1T) and one-capacitor (1C) memory cell. The DOSRAM is a DRAM formed using an OS transistor and temporarily stores information sent from the outside. The DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. In the case where a metal oxide is used in a semiconductor layer of a transistor, for example, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. For example, indium oxide (InOₓ) or an indium gallium zinc oxide (an In—Ga—Zn oxide, also referred to as “IGZO”) can be used for the channel formation region. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium is. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide included in the channel formation region may be, for example, a metal oxide that does not contain indium but contains any of zinc, gallium, and tin (e.g., a zinc tin oxide or a gallium tin oxide).

### Processing Unit 23

The processing unit 23 has a function of performing processing such as arithmetic operation, analysis, and inference with use of data supplied from one or both of the input unit 21 and the storage unit 22. The processing unit 23 can supply generated data (e.g., an arithmetic operation result, an analysis result, or an inference result) to one or both of the storage unit 22 and the output unit 24.

The processing unit 23 has a function of acquiring data from the storage unit 22. The processing unit 23 can also have a function of storing or registering data in the storage unit 22.

The processing unit 23 can include an arithmetic circuit, for example. The processing unit 23 can include, for example, a central processing unit (CPU). The processing unit 23 can also include a graphics processing unit (GPU). Furthermore, the processing unit 23 can include a neural processing unit (NPU, also referred to as a neural network processing unit).

The processing unit 23 can include a microprocessor such as a digital signal processor (DSP). The microprocessor can be achieved with a programmable logic device (PLD) such as a field programmable gate array (FPGA) or a field programmable analog array (FPAA). The processing unit 23 can also include a quantum processor. The processing unit 23 can interpret and execute instructions from various programs with use of a processor to process various kinds of data and control programs. The programs to be executed by the processor are stored in at least one of the storage unit 22 and a memory region of the processor.

The processing unit 23 can include a main memory. The main memory includes at least one of a volatile memory such as a RAM and a nonvolatile memory such as a read only memory (ROM). The main memory can include at least one of the above-described NOSRAM and DOSRAM.

Examples of the RAM include a DRAM and an SRAM; a virtual memory space is assigned and utilized as a working space of the processing unit 23. An operating system, an application program, a program module, program data, a look-up table, and the like which are stored in the storage unit 22 are loaded into the RAM for execution. The data, program, and program module which are loaded into the RAM are each directly accessed and operated by the processing unit 23.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 23 can include one or both of an OS transistor and a transistor including silicon in its channel formation region (Si transistor).

The processing unit 23 preferably includes an OS transistor. Since the OS transistor has an extremely low off-state current, a long data retention period can be ensured with use of the OS transistor as a switch for retaining electric charge (data) that has flowed into a capacitor functioning as a memory element. When this feature is imparted to at least one of a register and a cache memory included in the processing unit, the processing unit can be operated only when needed, and otherwise can be off while information processed immediately before turning off the processing unit is stored in the memory element. In other words, normally-off computing is possible and the power consumption of the information processing system can be reduced.

The information processing device preferably uses artificial intelligence (AI) for at least part of its processing.

In particular, the information processing device preferably uses an artificial neural network (ANN, hereinafter also simply referred to as a neural network). The neural network can be constructed with circuits (hardware) or programs (software).

In this specification and the like, the neural network indicates a general model having the capability of solving problems, which is modeled on a biological neural network and determines the connection strength of neurons by learning. The neural network includes an input layer, a middle layer (hidden layer), and an output layer.

In the description of the neural network in this specification and the like, determining a connection strength of neurons (also referred to as weight coefficients) from the existing information is referred to as “learning” in some cases.

In this specification and the like, drawing a new conclusion from a neural network formed with the connection strength obtained by learning is referred to as “inference” in some cases.

### Output Unit 24

The output unit 24 can output at least one of an arithmetic operation result, an analysis result, and an inference result in the processing unit 23 to the outside of the information processing device. For example, the output unit 24 can transmit data via the network 51. Specifically, a device such as a personal computer having a communication port or a communication function can be used. Furthermore, a device having a communication function may be used as each of the input unit 21 and the output unit 24.

### Transmission Path 25

The transmission path 25 has a function of transmitting data. Data transmission and reception between the input unit 21, the storage unit 22, the processing unit 23, and the output unit 24 can be performed via the transmission path 25. Specifically, an external bus, a LAN, or the Internet can be used for the transmission path 25.

This embodiment can be combined with any of the other embodiments in this specification as appropriate.

### Embodiment 2

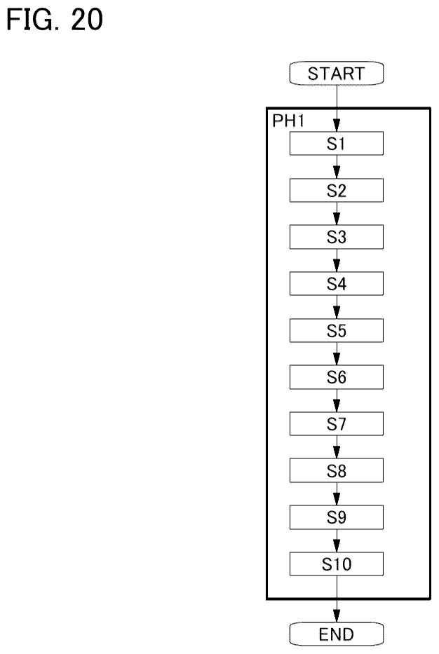

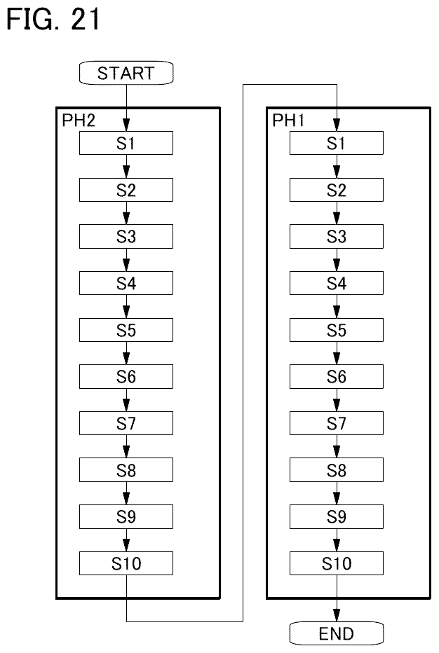

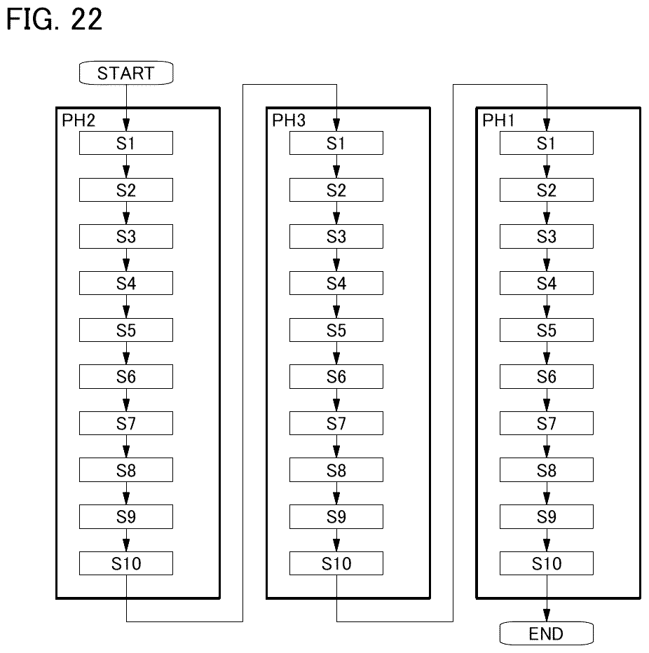

In this embodiment, an information processing method of one embodiment of the present invention will be described with reference to FIG. 20, FIG. 21, and FIG. 22.

FIG. 20 is a flow diagram illustrating the information processing method of one embodiment of the present invention.

FIG. 21 is a flow diagram illustrating the information processing method of one embodiment of the present invention.

FIG. 22 is a flow diagram illustrating the information processing method of one embodiment of the present invention.

### Example 1 of Information Processing Method

The information processing method of one embodiment of the present invention includes a phase PH1 (see FIG. 20).

### Phase PH1

The phase PH1 includes Step S1 to Step S10.

### Step S1

In Step S1, the component 110 receives the knowledge graphs KG0 and KG2 and transmits the knowledge graphs KG0 and KG2 to the component 120.

The knowledge graph KG0 includes the group of nodes Nd0. Each of the group of nodes Nd0 includes the field Fld00 and the field Fld01. The field Fld00 stores a document attribute ‘Scope of Claims (“Claim”)’. The field Fld01 stores one of the words or phrases Wd0 recognized as an element.

The knowledge graph KG2 includes the group of nodes Nd2. Each of the group of nodes Nd2 includes the field Fld20, the field Fld21, and the field Fld22. The field Fld20 has a function of storing a document attribute ‘Prior Art Document (“Ref”)’. The field Fld21 has a function of storing one of the words or phrases Wd2 recognized as an element. The field Fld22 has a function of storing the one of the words or phrases Wd0 or the false value False. The one of the words or phrases Wd0 is determined to have a correspondence with the one of the words or phrases Wd2.

### Step S2

In Step S2, the component 120 receives the knowledge graphs KG0 and KG2 and shares the knowledge graphs KG0 and KG2 within the component 120. The component 120 includes the subcomponent 120A and the subcomponent 120B.

### Step S3

In Step S3, the subcomponent 120A acquires the nodes Nd2(G) and Nd2(H) from the group of nodes Nd2 and acquires the nodes Nd0(A) and Nd0(B) from the group of nodes Nd0.

The node Nd2(G) stores the element Elem(G) in the field Fld21 and stores the element Elem(A) in the field Fld22.

The node Nd2(H) stores the element Elem(H) in the field Fld21 and stores the element Elem(B) in the field Fld22.

The node Nd0(A) stores the element Elem(A) in the field Fld01.

The node Nd0(B) stores the element Elem(B) in the field Fld01.

### Step S4

In Step S4, the subcomponent 120A searches for the path Pth0(AB) between the node Nd0(A) and the node Nd0(B).

### Step S5

In Step S5, the subcomponent 120A searches for the path Pth2(GH) between the node Nd2(G) and the node Nd2(H).

### Step S6

In Step S6, the subcomponent 120A shares the path Pth0(AB) and the path Pth2(GH) within the component 120.

### Step S7

In Step S7, the component 120 executes the prompt chain PC(02). The prompt chain PC(02) includes the prompt Pt30(0), the prompt Pt30(2), and the prompt Pt31(02).

The prompt Pt30(0) includes the instruction g30(0) and the path Pth0(AB). The instruction g30(0) includes a procedure for generating the document Doc(AB) that describes the relation between the element Elem(A) and the element Elem(B) using the path Pth0(AB).

The prompt Pt30(2) includes the instruction g30(2) and the path Pth2(GH). The instruction g30(2) includes a procedure for generating the document Doc(GH) that describes the relation between the element Elem(G) and the element Elem(H) using the path Pth2(GH).

The prompt Pt31(02) includes the instruction g31(02), the document Doc(AB), and the document Doc(GH). The instruction g31(02) includes a procedure for comparing the document Doc(AB) and the document Doc(GH) to generate the comparison document Doc(02) that describes the difference between the relation between the elements Elem(A) and Elem(B) and the relation between the elements Elem(G) and Elem(H).

### Step S8

In Step S8, the component 130 transmits the document Doc(AB), the document Doc(GH), and the comparison document Doc(02) to the component 120 in response to the prompt chain PC(02).

### Step S9

In Step S9, the component 120 receives the document Doc(AB), the document Doc(GH), and the comparison document Doc(02) and transmits the document Doc(AB), the document Doc(GH), and the comparison document Doc(02) to the component 110.

### Step S10

In Step S10, the component 110 receives the document Doc(AB), the document Doc(GH), and the comparison document Doc(02) and provides the document Doc(AB), the document Doc(GH), and the comparison document Doc(02) to the user 99 of the information processing system, for example.

In this manner, a node in the knowledge graph KG2 can be associated with a node in the knowledge graph KG0 using the field Fld22. Furthermore, a node associated with any of the group of nodes Nd0 in the knowledge graph KG0 can be selected from the group of nodes Nd2 in the knowledge graph KG2 using the field Fld22. Moreover, a pair of nodes can be acquired by selecting a node associated with any of the group of nodes Nd0 in the knowledge graph KG0 from the group of nodes Nd2 in the knowledge graph KG2. In addition, a pair of nodes in the knowledge graph KG0 corresponding to a pair of nodes in the knowledge graph KG2 can be found. Furthermore, a pair of nodes including the node Nd2(G) that stores the element Elem(A) in the field Fld22 and the node Nd2(H) that stores the element Elem(B) in the field Fld22 can be acquired from the knowledge graph KG2 to find a pair of nodes including the node Nd0(A) that stores the element Elem(A) in the field Fld21 and the node Nd0(B) that stores the element Elem(B) in the field Fld21 from the knowledge graph KG0, for example. In addition, the comparison document Doc(02) that describes the difference between a path connecting the nodes Nd0(A) and Nd0(B) and a path connecting the nodes Nd2(G) and Nd2(H) can be generated, for example. Moreover, the relation between elements of the invention in the scope of claims “Claim” can be compared with the relation between elements described in the prior art document “Ref”. Furthermore, the knowledge graph KG0 and the knowledge graph KG2 can be compared with each other to generate the comparison document Doc(02) that describes the comparison between a structure described in the scope of claims “Claim” and a structure described in the prior art document “Ref”. As a result, a novel information processing method that is highly convenient, useful, or reliable can be provided.

### Example 2 of Information Processing Method

The information processing method of one embodiment of the present invention includes the phase PH1 (see FIG. 20).

### Phase PH1

The phase PH1 includes Step S1 to Step S10.

### Step S1

In Step S1, the component 110 receives the knowledge graphs KG1 and KG2 and transmits the knowledge graphs KG1 and KG2 to the component 120.

The knowledge graph KG1 includes the group of nodes Nd1. Each of the group of nodes Nd1 includes the field Fld10, the field Fld11, and the field Fld12. The field Fld10 has a function of storing a document attribute ‘Specification (“Spec”)’. The field Fld11 has a function of storing one of the words or phrases Wd1 recognized as an element. The field Fld12 has a function of storing one of the words or phrases Wd0 or the false value False. The one of the words or phrases Wd0 is determined to have a correspondence with the one of the words or phrases Wd1.

The knowledge graph KG2 includes the group of nodes Nd2. Each of the group of nodes Nd2 includes the field Fld20, the field Fld21, and the field Fld22. The field Fld20 has a function of storing a document attribute ‘Prior Art Document (“Ref”)’. The field Fld21 has a function of storing one of the words or phrases Wd2 recognized as an element. The field Fld22 has a function of storing the one of the words or phrases Wd0 or the false value False. The one of the words or phrases Wd0 is determined to have a correspondence with the one of the words or phrases Wd2.

### Step S2

In Step S2, the component 120 receives the knowledge graphs KG1 and KG2 and shares the knowledge graphs KG1 and KG2 within the component 120. The component 120 includes the subcomponent 120A and the subcomponent 120B.

### Step S3

In Step S3, the subcomponent 120A acquires the nodes Nd2(G) and Nd2(H) from the group of nodes Nd2 and acquires the nodes Nd1(a) and Nd1(b) from the group of nodes Nd1.

The node Nd2(G) stores the element Elem(G) in the field Fld21 and stores the element Elem(A) in the field Fld22.

The node Nd2(H) stores the element Elem(H) in the field Fld21 and stores the element Elem(B) in the field Fld22.

The node Nd1(a) stores the element Elem(a) in the field Fld11 and stores the element Elem(A) in the field Fld12.

The node Nd1(b) stores the element Elem(b) in the field Fld11 and stores the element Elem(B) in the field Fld12.

### Step S4

In Step S4, the subcomponent 120A searches for the path Pth1(ab) between the node Nd1(a) and the node Nd1(b).

### Step S5

In Step S5, the subcomponent 120A searches for the path Pth2(GH) between the node Nd2(G) and the node Nd2(H).

### Step S6

In Step S6, the subcomponent 120A shares the path Pth1(ab) and the path Pth2(GH) within the component 120.

### Step S7

In Step S7, the component 120 executes the prompt chain PC(12). The prompt chain PC(12) includes the prompt Pt30(1), the prompt Pt30(2), and the prompt Pt31(12).

The prompt Pt30(1) includes the instruction g30(1) and the path Pth1(ab). The instruction g30(1) includes a procedure for generating the document Doc(ab) that describes the relation between the element Elem(a) and the element Elem(b) using the path Pth1(ab).

The prompt Pt30(2) includes the instruction g30(2) and the path Pth2(GH). The instruction g30(2) includes a procedure for generating the document Doc(GH) that describes the relation between the element Elem(G) and the element Elem(H) using the path Pth2(GH).

The prompt Pt31(12) includes the instruction g31(12), the document Doc(ab), and the document Doc(GH). The instruction g31(12) includes a procedure for comparing the document Doc(ab) and the document Doc(GH) to generate the comparison document Doc(12) that describes the difference between the relation between the elements Elem(a) and Elem(b) and the relation between the elements Elem(G) and Elem(H).

### Step S8

In Step S8, the component 130 transmits the document Doc(ab), the document Doc(GH), and the comparison document Doc(12) to the component 120 in response to the prompt chain PC(12).

### Step S9

In Step S9, the component 120 receives the document Doc(ab), the document Doc(GH), and the comparison document Doc(12) and transmits the document Doc(ab), the document Doc(GH), and the comparison document Doc(12) to the component 110.

### Step S10

In Step S10, the component 110 receives the document Doc(ab), the document Doc(GH), and the comparison document Doc(12) and provides the document Doc(ab), the document Doc(GH), and the comparison document Doc(12) to the user 99 of the information processing system, for example.

In this manner, a node in the knowledge graph KG2 can be associated with a node in the knowledge graph KG1 using the field Fld22. Furthermore, a node associated with any of the group of nodes Nd1 in the knowledge graph KG1 can be selected from the group of nodes Nd2 in the knowledge graph KG2 using the field Fld22. Moreover, a pair of nodes can be acquired by selecting a node associated with any of the group of nodes Nd1 in the knowledge graph KG1 from the group of nodes Nd2 in the knowledge graph KG2. In addition, a pair of nodes in the knowledge graph KG1 corresponding to a pair of nodes in the knowledge graph KG2 can be found. Furthermore, a pair of nodes including the node Nd2(G) that stores the element Elem(A) in the field Fld22 and the node Nd2(H) that stores the element Elem(B) in the field Fld22 can be acquired from the knowledge graph KG2 to find a pair of nodes including the node Nd1(a) that stores the element Elem(A) in the field Fld12 and the node Nd1(b) that stores the element Elem(B) in the field Fld12 from the knowledge graph KG1, for example. In addition, the comparison document Doc(12) that describes the difference between a path connecting the nodes Nd1(a) and Nd1(b) and a path connecting the nodes Nd2(G) and Nd2(H) can be generated, for example. Moreover, the relation between elements described in the specification “Spec” in which the subject-matter of the invention is described can be compared with the relation between elements described in the prior art document “Ref”. Furthermore, the knowledge graph KG1 and the knowledge graph KG2 can be compared with each other to generate the comparison document Doc(12) that describes the comparison between a structure described in the specification “Spec” in which the subject-matter of the invention is described and a structure described in the prior art document “Ref”. As a result, a novel information processing method that is highly convenient, useful, or reliable can be provided.

### Example 3 of Information Processing Method

The information processing method of one embodiment of the present invention includes the phase PH1 and a phase PH2 (see FIG. 21).

### Phase PH1

The phase PH1 described above in Example 1 of information processing method follows the phase PH2 described below.

### Phase PH2

The phase PH2 includes Step S1 to Step S10.

### Step S1

In Step S1, the component 110 receives the document Doc(0) and transmits the document Doc(0) to the component 120. The document Doc(0) is a document in which the scope of claims “Claim” is described.

### Step S2

In Step S2, the component 120 receives the document Doc(0) and shares the document Doc(0) within the component 120. The component 120 includes the subcomponent 120C.

### Step S3

In Step S3, the subcomponent 120C creates the element list EL0 and shares the element list EL0 within the component 120. The element list EL0 stores the words or phrases Wd0 recognized as elements in the document Doc(0) by natural language processing.

### Step S4

In Step S4, the subcomponent 120B sequentially selects the pair of elements PoE0 from the element list EL0.

### Step S5

In Step S5, the subcomponent 120B creates the prompt Pt0 and transmits the prompt Pt0 to the component 130.

The prompt Pt0 includes the instruction g0( ), the pair of elements PoE0, and the document Doc(0). The instruction g0( ) includes a procedure for generating the inference result IR0 from the document Doc(0). The inference result IR0 includes the expression EDR0(XY) for describing the relation between the pair of elements PoE0.

### Step S6

In Step S6, the component 130 receives the prompt Pt0, generates the inference result IR0 using the large language model LLM, and transmits the inference result IR0 to the component 120.

### Step S7

In Step S7, the subcomponent 120A creates the graph data GD0(XY) from the inference result IR0. The graph data GD0(XY) includes the node Nd0(X), the node Nd0(Y), and the edge Edg0(XY).

The node Nd0(X) stores a document attribute ‘Scope of Claims (“Claim”)’ in the field Fld00 and stores one of the pair of elements PoE0 in the field Fld01.

The node Nd0(Y) stores a document attribute ‘Scope of Claims (“Claim”)’ in the field Fld00 and stores the other of the pair of elements PoE0 in the field Fld01.

The edge Edg0(XY) includes the field Fld05. The field Fld05 stores the expression EDR0(XY) for describing the relation between the element Elem(X) and the element Elem(Y).

### Step S8

In Step S8, the subcomponent 120A adds the graph data GD0(XY) to the knowledge graph KG0 and shares the knowledge graph KG0 within the component 120.

### Step S9

In Step S9, the component 120 transmits the knowledge graph KG0 to the component 110.

### Step S10

In Step S10, the component 110 receives the knowledge graph KG0 and provides the knowledge graph KG0 to the user 99 of the information processing system, for example.

In the case where the elements Elem(A) and Elem(B) are selected as the pair of elements, for example, the elements Elem(A) and Elem(B) described in the scope of claims “Claim” and the expression EDR0(AB) for describing the relation between the elements Elem(A) and Elem(B) can be stored in the graph data GD0(AB), for example. Furthermore, the graph data GD0(AB) can be added to the knowledge graph KG0. Moreover, elements of the invention in the scope of claims “Claim” and the relation between the elements can be expressed in the form of the knowledge graph KG0. As a result, a novel information processing method that is highly convenient, useful, or reliable can be provided.

### Example 4 of Information Processing Method

The information processing method of one embodiment of the present invention includes the phase PH1 and a phase PH2 (see FIG. 21).

### Phase PH1

The phase PH1 described above in Example 2 of information processing method follows the phase PH2 described below.

### Phase PH2

The phase PH2 includes Step S1 to Step S10.

### Step S1

In Step S1, the component 110 receives the document Doc(1) and the correspondence list CL and transmits the document Doc(1) and the correspondence list CL to the component 120. The document Doc(1) is the specification “Spec” in which the subject-matter of the invention is described. The one of the words or phrases Wd1 determined to have a correspondence with the one of the words or phrases Wd0 is stored in the correspondence list CL in association with the one of the words or phrases Wd0.

### Step S2

In Step S2, the component 120 receives the document Doc(1) and the correspondence list CL and shares the document Doc(1) and the correspondence list CL within the component 120. The component 120 includes the subcomponent 120C.

### Step S3

In Step S3, the subcomponent 120C creates the element list EL1 and shares the element list EL1 within the component 120. The element list EL1 stores the words or phrases Wd1 recognized as elements in the document Doc(1) by natural language processing.

### Step S4

In Step S4, the subcomponent 120B sequentially selects the pair of elements PoE1 from the element list EL1.

### Step S5

In Step S5, the subcomponent 120B creates the prompt Pt1 and transmits the prompt Pt1 to the component 130.

The prompt Pt1 includes the instruction g1( ), the pair of elements PoE1, and the document Doc(1). The instruction g1( ) includes a procedure for generating the inference result IR1 from the document Doc(1). The inference result IR1 includes the expression EDR1(XY) for describing the relation between the pair of elements PoE1.

### Step S6

In Step S6, the component 130 receives the prompt Pt1, generates the inference result IR1 using the large language model LLM, and transmits the inference result IR1 to the component 120.

### Step S7

In Step S7, the subcomponent 120A creates the graph data GD1(XY) from the inference result IR1. The graph data GD1(XY) includes the node Nd1(X), the node Nd1(Y), and the edge Edg1(XY).

The node Nd1(X) stores a document attribute ‘Specification (“Spec”)’ in the field Fld10 and stores one of the pair of elements PoE1 in the field Fld11.

In the case where the one of the pair of elements PoE1 is associated with the element Elem(P) in the correspondence list CL, the element Elem(P) is stored in the field Fld12. In the case where the one of the pair of elements PoE1 is associated with no element in the correspondence list CL, the false value False is stored in the field Fld12.

The node Nd1(Y) stores a document attribute ‘Specification (“Spec”)’ in the field Fld10 and stores the other of the pair of elements PoE1 in the field Fld11.

In the case where the other of the pair of elements PoE1 is associated with the element Elem(Q) in the correspondence list CL, the element Elem(Q) is stored in the field Fld12. In the case where the other of the pair of elements PoE1 is associated with no element in the correspondence list CL, the false value False is stored in the field Fld12.

The edge Edg1(XY) includes the field Fld15. The field Fld15 stores the expression EDR1(XY) for describing the relation between the element Elem(X) and the element Elem(Y).

### Step S8

In Step S8, the subcomponent 120A adds the graph data GD1(XY) to the knowledge graph KG1 and shares the knowledge graph KG1 within the component 120.

### Step S9

In Step S9, the component 120 transmits the knowledge graph KG1 to the component 110.

### Step S10

In Step S10, the component 110 receives the knowledge graph KG1 and provides the knowledge graph KG1 to the user 99 of the information processing system, for example.

In the case where the elements Elem(a) and Elem(c) are selected as the pair of elements, for example, the elements Elem(a) and Elem(c) described in the specification “Spec” in which the subject-matter of the invention is described and the expression EDR1(ac) for describing the relation between the elements Elem(a) and Elem(c) can be stored in the graph data GD1(ac), for example. Furthermore, the graph data GD1(ac) can be added to the knowledge graph KG1(ac). In the node Nd1(a) where the element Elem(a) is stored in the field Fld11, the element Elem(A) can be stored in the field Fld12 in accordance with the correspondence list CL. In the case where the element Elem(c) is associated with no element in the correspondence list CL, the false value False can be stored in the field Fld12 of the node Nd1(c) where the element Elem(c) is stored in the field Fld11. Moreover, elements of the invention described in the specification “Spec” and the relation between the elements can be expressed in the form of the knowledge graph KG1. As a result, a novel information processing method that is highly convenient, useful, or reliable can be provided.

### Example 5 of Information Processing Method

The information processing method of one embodiment of the present invention includes the phase PH1, the phase PH2, and a phase PH3 (see FIG. 22).

### Phase PH1

The phase PH1 described above in Example 1 of information processing method or Example 2 of information processing method follows the phase PH3 described below.

### Phase PH3

The phase PH3 follows the phase PH2 described above in Example 3 of information processing method or Example 4 of information processing method. The phase PH3 includes Step S1 to Step S10.

### Step S1

In Step S1, the component 110 receives the document Doc(2) and the correspondence list CL and transmits the document Doc(2) and the correspondence list CL to the component 120. The document Doc(2) is the prior art document “Ref”. The one of the words or phrases Wd2 determined to have a correspondence with the one of the words or phrases Wd0 is stored in the correspondence list CL in association with the one of the words or phrases Wd0.

### Step S2

In Step S2, the component 120 receives the document Doc(2) and the correspondence list CL and shares the document Doc(2) and the correspondence list CL within the component 120. The component 120 includes the subcomponent 120C.

### Step S3

In Step S3, the subcomponent 120C creates the element list EL2 and shares the element list EL2 within the component 120. The element list EL2 stores the words or phrases Wd2 recognized as elements in the document Doc(2) by natural language processing.

### Step S4

In Step S4, the subcomponent 120B sequentially selects the pair of elements PoE2 from the element list EL2.

### Step S5

In Step S5, the subcomponent 120B creates the prompt Pt2 and transmits the prompt Pt2 to the component 130.

The prompt Pt2 includes the instruction g2( ), the pair of elements PoE2, and the document Doc(2). The instruction g2( ) includes a procedure for generating the inference result IR2 from the document Doc(2). The inference result IR2 includes the expression EDR2(XY) for describing the relation between the pair of elements PoE2.

### Step S6

In Step S6, the component 130 receives the prompt Pt2, generates the inference result IR2 using the large language model LLM, and transmits the inference result IR2 to the component 120.

### Step S7

In Step S7, the subcomponent 120A creates the graph data GD2(XY) from the inference result IR2. The graph data GD2(XY) includes the node Nd2(X), the node Nd2(Y), and the edge Edg2(XY).

The node Nd2(X) stores a document attribute ‘Prior Art Document (“Ref”)’ in the field Fld20 and stores one of the pair of elements PoE2 in the field Fld21.

In the case where the one of the pair of elements PoE2 is associated with the element Elem(P) in the correspondence list CL, the element Elem(P) is stored in the field Fld22. In the case where the one of the pair of elements PoE2 is associated with no element in the correspondence list CL, the false value False is stored in the field Fld22.

The node Nd2(Y) stores a document attribute ‘Prior Art Document (“Ref”)’ in the field Fld20 and stores the other of the pair of elements PoE2 in the field Fld21.

In the case where the other of the pair of elements PoE2 is associated with the element Elem(Q) in the correspondence list CL, the element Elem(Q) is stored in the field Fld22. In the case where the other of the pair of elements PoE2 is associated with no element in the correspondence list CL, the false value False is stored in the field Fld22.

The edge Edg2(XY) includes the field Fld25. The field Fld25 stores the expression EDR2(XY) for describing the relation between the element Elem(X) and the element Elem(Y).

### Step S8

In Step S8, the subcomponent 120A adds the graph data GD2(XY) to the knowledge graph KG2 and shares the knowledge graph KG2 within the component 120.

### Step S9

In Step S9, the component 120 transmits the knowledge graph KG2 to the component 110.

### Step S10

In Step S10, the component 110 receives the knowledge graph KG2 and provides the knowledge graph KG2 to the user 99 of the information processing system, for example.

In the case where the elements Elem(G) and Elem(I) are selected as the pair of elements, for example, the elements Elem(G) and Elem(I) described in the prior art document “Ref” and the expression EDR2(GI) for describing the relation between the elements Elem(G) and Elem(I) can be stored in the graph data GD2(GI), for example. Furthermore, the graph data GD2(GI) can be added to the knowledge graph KG2. In the node Nd2(G) where the element Elem(G) is stored in the field Fld21, the element Elem(A) can be stored in the field Fld22 in accordance with the correspondence list CL. In the case where the element Elem(I) is associated with no element in the correspondence list CL, the false value False can be stored in the field Fld22 of the node Nd2(I) where the element Elem(I) is stored in the field Fld21. Moreover, elements of the prior art described in the prior art document “Ref” and the relation between the elements can be expressed in the form of the knowledge graph KG2. As a result, a novel information processing method that is highly convenient, useful, or reliable can be provided.

This embodiment can be combined with any of the other embodiments in this specification as appropriate.

This application is based on Japanese Patent Application Serial No. 2024-213175 filed with Japan Patent Office on Dec. 6, 2024, the entire contents of which are hereby incorporated by reference.

What is claimed is:

1. An information processing system comprising:
a first component;
a second component; and
a third component comprising a first subcomponent and a second subcomponent,
wherein the first component is configured to receive a first knowledge graph comprising a first group of nodes and transmit the first knowledge graph to the third component,
wherein each node of the first group of nodes comprises a first field storing an attribute showing a scope of claims and a second field storing one of a first word of a plurality of first words and a first phrase of a plurality of first phrases recognized as an element in the scope of claims,
wherein the second component is configured to perform processing using a large language model,
wherein the large language model is configured to generate a first document in response to a first prompt,
wherein the first document describes a first relation between a first element and a second element,
wherein each of the first element and the second element is one of the plurality of first words or one of the plurality of first phrases,
wherein the second component is configured to transmit the first document to the third component in response to a prompt chain,
wherein the third component is configured to execute the prompt chain comprising the first prompt,
wherein the first subcomponent is configured to acquire a first node storing the first element in the second field and a second node storing the second element in the second field from the first group of nodes,
wherein the first subcomponent is configured to search for a first path between the first node and the second node,
wherein the second subcomponent is configured to create the first prompt,
wherein the first prompt comprises a first instruction and the first path, and
wherein the first instruction comprises a procedure for generating the first document describing the first relation between the first element and the second element using the first path.

2. The information processing system according to claim 1,
wherein the large language model is configured to generate a second document in response to a second prompt,
wherein the first component is configured to receive a second knowledge graph and the second document,
wherein the second knowledge graph comprises a second group of nodes,
wherein each node of the second group of nodes comprises a third field, a fourth field, and a fifth field,
wherein the third field stores an attribute showing a prior art document,
wherein the fourth field stores one of a second word of a plurality of second words and a second phrase of a plurality of second phrases recognized as an element,
wherein the fifth field stores the one of the first word of the plurality of first words and the first phrase of the plurality of first phrases or a false value,
wherein the one of the first word of the plurality of first words and the first phrase of the plurality of first phrases is determined to have a correspondence with the one of the second word of the plurality of second words and the second phrase of the plurality of second phrases,
wherein the second document describes a second relation between a third element and a fourth element,
wherein each of the third element and the fourth element is one of the plurality of second words or one of the plurality of second phrases,
wherein the second component is configured to transmit the second document to the third component in response to the prompt chain comprising the second prompt,
wherein the third component is configured to receive the second knowledge graph and the second document,
wherein the first subcomponent is configured to acquire a third node and a fourth node from the second group of nodes,
wherein the third node stores the third element in the fourth field and stores the first element in the fifth field,
wherein the fourth node stores the fourth element in the fourth field and stores the second element in the fifth field,
wherein the first subcomponent is configured to search for a second path between the third node and the fourth node,
wherein the second subcomponent is configured to create the second prompt,
wherein the second prompt comprises a second instruction and the second path, and
wherein the second instruction comprises a procedure for generating the second document describing the second relation between the third element and the fourth element using the second path.

3. The information processing system according to claim 2,
wherein the first component is configured to receive and provide a comparison document,
wherein the comparison document describes a difference between the first relation between the first element and the second element and the second relation between the third element and the fourth element,
wherein the second component is configured to transmit the comparison document to the third component in response to the prompt chain,
wherein the large language model is configured to generate the comparison document in response to a third prompt,
wherein the third component is configured to receive the comparison document and transmit the comparison document to the first component,
wherein the prompt chain comprises the third prompt,
wherein the second subcomponent is configured to create the third prompt,
wherein the third prompt comprises a third instruction, the first document, and the second document, and
wherein the third instruction comprises a procedure for comparing the first document and the second document to generate the comparison document describing the difference between the first relation between the first element and the second element and the second relation between the third element and the fourth element.

4. The information processing system according to claim 1,
wherein the first component is configured to receive a second document and transmit the second document to the third component and is configured to receive and provide the first knowledge graph,
wherein the second document describes the scope of claims,
wherein the first knowledge graph corresponds to the second document converted into a graph format,
wherein the second component is configured to receive a second prompt and transmit a first inference result to the third component,
wherein the large language model is configured to generate the first inference result in response to the second prompt,
wherein the third component is configured to receive the second document and transmit the second prompt to the second component and is configured to receive the first inference result and transmit the first knowledge graph to the first component,
wherein the third component comprises a third subcomponent,
wherein the third subcomponent is configured to perform natural language processing and is configured to create a first element list,
wherein the first element list stores the plurality of first words and the plurality of first phrases recognized as elements in the second document by the natural language processing,
wherein the second subcomponent is configured to sequentially select a first pair of elements from the first element list and is configured to create the second prompt,
wherein the second prompt comprises a second instruction, the first pair of elements, and the second document,
wherein the second instruction comprises a procedure for generating the first inference result from the second document,
wherein the first inference result comprises an expression for describing a second relation between one element of the first pair of elements and the other element of the first pair of elements,
wherein the first subcomponent is configured to create first graph data from the first inference result and is configured to add the first graph data to the first knowledge graph,
wherein the first graph data comprises a third node, a fourth node, and a first edge,
wherein the third node stores the attribute showing the scope of claims in the first field and stores the one element of the first pair of elements in the second field,
wherein the fourth node stores the attribute showing the scope of claims in the first field and stores the other element of the first pair of elements in the second field,
wherein the first edge comprises a third field, and
wherein the third field stores the expression for describing the second relation.

5. The information processing system according to claim 2,
wherein the first component is configured to receive a third document, a correspondence list, and the second knowledge graph,
wherein the third document is the prior art document,
wherein the one of the second word of the plurality of second words and the second phrase of the plurality of second phrases determined to have a correspondence with the one of the first word of the plurality of first words and the first phrase of the plurality of first phrases is stored in the correspondence list in association with the one of the first word of the plurality of first words and the first phrase of the plurality of first phrases,
wherein the second knowledge graph corresponds to the third document converted into a graph format,
wherein the second component is configured to receive a third prompt from the third component and transmit a second inference result generated by the large language model to the third component in response to the third prompt,
wherein the third component comprising a third subcomponent is configured to receive the correspondence list and the second inference result and transmit the second knowledge graph to the first component,
wherein the third subcomponent is configured to perform natural language processing and is configured to create a second element list,
wherein the second element list stores the plurality of second words and the plurality of second phrases recognized as elements in the third document by the natural language processing,
wherein the second subcomponent is configured to sequentially select a second pair of elements from the second element list and is configured to create the third prompt,
wherein the third prompt comprises a third instruction, the second pair of elements, and the third document,
wherein the third instruction comprises a procedure for generating the second inference result from the third document,
wherein the second inference result comprises an expression for describing a third relation between one element of the second pair of elements and the other element of the second pair of elements,
wherein the first subcomponent is configured to create third graph data from the second inference result and is configured to add the third graph data to the second knowledge graph,
wherein the third graph data comprises a fifth node, a sixth node, and a second edge,
wherein the fifth node stores the attribute showing the prior art document in the third field and stores the one element of the second pair of elements in the fourth field,
wherein, in the case where the one element of the second pair of elements is associated with a fifth element in the correspondence list, the fifth element is stored in the fifth field,
wherein, in the case where the one element of the second pair of elements is associated with no element in the correspondence list, the false value is stored in the fifth field,
wherein the sixth node stores the attribute showing the prior art document in the third field and stores the other element of the second pair of elements in the fourth field,
wherein, in the case where the other element of the second pair of elements is associated with a sixth element in the correspondence list, the sixth element is stored in the fifth field,
wherein, in the case where the other element of the second pair of elements is associated with no element in the correspondence list, the false value is stored in the fifth field,
wherein the second edge comprises a seventh field, and
wherein the seventh field stores the expression for describing the third relation.

6. The information processing system according to claim 1,
wherein each node of the first group of nodes comprises a third field,
wherein, when the first field stores an attribute showing a specification instead of the scope of claims, the third field stores one of a second word of a plurality of second words and a second phrase of a plurality of second phrases or a false value,
wherein the one of the second word of the plurality of second words and the second phrase of the plurality of second phrases is determined to have a correspondence with the one of the first word of the plurality of first words and the first phrase of the plurality of first phrases,
wherein the first node stores a third element in the third field, and
wherein the second node stores a fourth element in the third field.

7. An information processing method comprising:
a first phase,
wherein the first phase comprises a first step, a second step, a third step, a fourth step, a fifth step, a sixth step, a seventh step, an eighth step, a ninth step, and a tenth step,
wherein, in the first step of the first phase, a first component receives a first knowledge graph and a second knowledge graph and transmits the first knowledge graph and the second knowledge graph to a second component,
wherein the first knowledge graph comprises a first group of nodes,
wherein each of the first group of nodes comprises a first field and a second field,
wherein the first field stores an attribute showing a scope of claims,
wherein the second field stores one of first words or phrases recognized as an element in the scope of claims,
wherein the second knowledge graph comprises a second group of nodes,
wherein each of the second group of nodes comprises a third field, a fourth field, and a fifth field,
wherein the third field stores an attribute showing a prior art document,
wherein the fourth field stores one of second words or phrases recognized as an element,
wherein the fifth field stores the one of the first words or phrases or a false value,
wherein the one of the first words or phrases is determined to have a correspondence with the one of the second words or phrases,
wherein, in the second step of the first phase, the second component receives the first knowledge graph and the second knowledge graph and shares the first knowledge graph and the second knowledge graph within the second component,
wherein the second component comprises a first subcomponent and a second subcomponent,
wherein, in the third step of the first phase, the first subcomponent acquires a first node and a second node from the second group of nodes and acquires a third node and a fourth node from the first group of nodes,
wherein the first node stores a first element in the fourth field and stores a second element in the fifth field,
wherein the second node stores a third element in the fourth field and stores a fourth element in the fifth field,
wherein the third node stores the second element in the second field,
wherein the fourth node stores the fourth element in the second field,
wherein, in the fourth step of the first phase, the first subcomponent searches for a first path between the third node and the fourth node,
wherein, in the fifth step of the first phase, the first subcomponent searches for a second path between the first node and the second node,
wherein, in the sixth step of the first phase, the first subcomponent shares the first path and the second path within the second component,
wherein, in the seventh step of the first phase, the second component executes a first prompt chain,
wherein the first prompt chain comprises a first prompt, a second prompt, and a third prompt,
wherein the first prompt comprises a first instruction and the first path,
wherein the first instruction comprises a procedure for generating a first document describing a relation between the second element and the fourth element using the first path,
wherein the second prompt comprises a second instruction and the second path,
wherein the second instruction comprises a procedure for generating a second document describing a relation between the first element and the third element using the second path,
wherein the third prompt comprises a third instruction, the first document, and the second document,
wherein the third instruction comprises a procedure for comparing the first document and the second document to generate a first comparison document describing a difference between the relation between the second element and the fourth element and the relation between the first element and the third element,
wherein, in the eighth step of the first phase, a third component transmits the first document, the second document, and the first comparison document to the second component in response to the first prompt chain,
wherein, in the ninth step of the first phase, the second component receives the first document, the second document, and the first comparison document and transmits the first document, the second document, and the first comparison document to the first component, and
wherein, in the tenth step of the first phase, the first component receives and provides the first document, the second document, and the first comparison document.

8. The information processing method according to claim 7, comprising:
the first phase; and
a second phase,
wherein the first phase follows the second phase,
wherein the second phase comprises a first step, a second step, a third step, a fourth step, a fifth step, a sixth step, a seventh step, an eighth step, a ninth step, and a tenth step,
wherein, in the first step of the second phase, the first component receives a fourth document and transmits the fourth document to the second component,
wherein the fourth document describes the scope of claims,
wherein, in the second step of the second phase, the second component receives the fourth document and shares the fourth document within the second component,
wherein the second component comprises a third subcomponent,
wherein, in the third step of the second phase, the third subcomponent creates a first element list and shares the first element list within the second component,
wherein the first element list stores the first words or phrases recognized as elements in the fourth document by natural language processing,
wherein, in the fourth step of the second phase, the second subcomponent sequentially selects a first pair of elements from the first element list,
wherein, in the fifth step of the second phase, the second subcomponent creates a sixth prompt and transmits the sixth prompt to the third component,
wherein the sixth prompt comprises a sixth instruction, the first pair of elements, and the fourth document,
wherein the sixth instruction comprises a procedure for generating a first inference result from the fourth document,
wherein the first inference result comprises an expression for describing a first relation between one of the first pair of elements and the other of the first pair of elements,
wherein, in the sixth step of the second phase, the third component receives the sixth prompt, generates the first inference result using a large language model, and transmits the first inference result to the second component,
wherein, in the seventh step of the second phase, the first subcomponent creates first graph data from the first inference result,
wherein the first graph data comprises a seventh node, an eighth node, and a first edge,
wherein the seventh node stores the attribute showing the scope of claims in the first field and stores the one of the first pair of elements in the second field,
wherein the eighth node stores the attribute showing the scope of claims in the first field and stores the other of the first pair of elements in the second field,
wherein the first edge comprises a ninth field,
wherein the ninth field stores the expression for describing the first relation,
wherein, in the eighth step of the second phase, the first subcomponent adds the first graph data to the first knowledge graph and shares the first knowledge graph within the second component,
wherein, in the ninth step of the second phase, the second component transmits the first knowledge graph to the first component, and
wherein, in the tenth step of the second phase, the first component receives and provides the first knowledge graph.
